(19) United States
(12) Patent Application Publication
(10) Pub. No.: US 2014/0049738 A1
(43) Pub. Date: Feb. 20, 2014

(54) THREE-DIMENSIONAL IMAGE DISPLAY APPARATUS

(71) Applicants: JNC PETROCHEMICAL CORPORATION, Tokyo (JP); JNC CORPORATION, Tokyo (JP)

(72) Inventor: Yoshiharu Hirai, Chiba (JP)

(73) Assignees: JNC PETROCHEMICAL CORPORATION, Tokyo (JP); JNC CORPORATION, Tokyo (JP)

(21) Appl. No.: 13/948,030

(22) Filed: Jul. 22, 2013

(30) Foreign Application Priority Data
Aug. 20, 2012 (JP) 2012-181934

(51) Int. Cl. G02F 1/1337

(52) U.S. Cl. CPC G02F 1/1337
USPC 349/123

(57) ABSTRACT

To provide a three-dimensional image display apparatus having patterned retarder 303 that is excellent in adhesion between transparent support substrate 301 and alignment film 302. A mixture containing a polymerizable liquid crystal compound and a peeling preventive agent is prepared. Here, the peeling preventive agent has as a polar group any one of a hydroxyl group, a carboxyl group, a phosphate group, a sulfonate group, an amino group, a mercapto group and an isocyanate group, and also has a polymerizable group. Then, an alignment layer is arranged on a transparent support substrate, and subjected to patterned treatment, and the mixture is coated, and a coated surface is dried and cured to form a patterned retarder, and thus a three-dimensional image display apparatus having excellent reliability, such as adhesion, is obtained.

### CROSS-REFERENCE TO RELATED APPLICATIONS

This application claims the benefit of Japanese Patent Application No. 2012-181934, filed Aug. 20, 2012, in the Japanese Patent Office, all disclosures of the document(s) named above are incorporated herein by reference.

### BACKGROUND OF THE INVENTION

1. Field of the Invention

The present invention relates to a three-dimensional image display apparatus. In particular, the invention relates to a three-dimensional image display apparatus having an image-forming unit, and a polarization-axis control plate for outgoing, upon incoming of right-eye image light including a right-eye image and left-eye image light including a left-eye image as formed in the image-forming unit, the image light as linearly polarized light in which polarization axes are crossed at a right angle with each other, or circularly polarized light in which directions of rotation of the polarization axes are in a reverse direction with each other.

2. Description of the Related Art

As an apparatus for allowing an observer to recognize a three-dimensional image, an image display apparatus is known in which the apparatus includes an image-forming unit for displaying an image for a right eye and an image for a left eye on different regions, respectively, and a polarization-axis control plate for crossing at a right angle with each other polarization axes of polarized light that enters into two different regions (see Patent literature Nos. 1 to 3, for example). A retarder used for the relevant three-dimensional image display apparatus is prepared as a patterned retarder mainly by allowing as a retardant material a polymerizable liquid crystal compound having a liquid crystal phase to apply onto an alignment layer subjected to patterned alignment treatment, and perform photocure of the polymerizable liquid crystal compound. However, a patterned retarder consisting of the polymerizable liquid crystal compound has a problem of insufficient adhesion with regard to an interface between the alignment layer and a polymerizable liquid crystal layer. If the adhesion is insufficient, for example, when a protective film is stuck on the patterned retarder for preventing scratching, fouling or the like during transportation, upon removing the protective film, the liquid crystal layer of the patterned retarder deposits on an adhesive surface side of the protective film, and thus the patterned retarder may be occasionally damaged. In order to solve such a problem, a patterned retarder including a polymerizable liquid crystal layer containing a peeling preventive agent has been desired (see Patent literature No. 4).

### CITATION LIST

### Patent Literature

Patent literature No. 1: JP H10-232364 A.
Patent literature No. 2: JP 2004-264338 A.
Patent literature No. 3: JP 2008-304909 A.
Patent literature No. 4: WO 2011/049326 A.

### SUMMARY OF THE INVENTION

### Technical Problem

An object of the invention is to provide a three-dimensional image display apparatus having satisfactory adhesion between patterned retarder 303 and alignment film 302 formed on transparent support substrate 301. Another object of the invention is to provide a liquid crystal display apparatus including patterned retarder 303 having excellent adhesion with alignment film 302 formed on transparent support substrate 301, and also to provide a three-dimensional image display apparatus of an organic EL display apparatus.

### Solution to Problem

The present inventors have found that, when a non-liquid crystalline polymerizable liquid crystal compound having as a polar group, a hydroxyl group, a carboxyl group, a phosphate group, a sulfonate group, an amino group, a mercapto group or an isocyanate group, or a polymer having as a polar group at least one of a hydroxyl group, a carboxyl group, a phosphate group, a sulfonate group, an amino group, a mercapto group and an isocyanate group is simultaneously used, as a peeling preventive agent, for a polymerizable liquid crystal compound for forming patterned retarder 303, adhesion is improved between polymerizable liquid crystal layer 303 and alignment film 302 to be formed on transparent support substrate 301 and subjected to patterned alignment treatment, and thus have completed the invention. The peeling preventive agent being the non-liquid crystalline polymerizable compound has at least one polymerizable group, and is polymerizable in a manner similar to a polymerizable liquid crystal compound. The three-dimensional image display apparatus of the invention is described in item 1 and item 2 described below.

Item 1. A three-dimensional image display apparatus, comprising a patterned retarder prepared by arranging on a transparent support substrate an alignment film subjected to treatment so as to be in a state in which alignment directions of liquid crystal molecules are different in adjacent regions in an identical plane, arranging on the alignment film a polymerizable liquid crystal layer including a polymerizable liquid crystal compound and a peeling preventive agent, and subsequently allowing the polymerizable liquid crystal compound to align in a direction of alignment treatment of the alignment film, and immobilizing alignment of the polymerizable liquid crystal compound by irradiation with light.

Item 2. A three-dimensional image display apparatus, comprising a patterned retarder prepared by arranging on a transparent support substrate an alignment film subjected to treatment so as for a direction of alignment of liquid crystal molecules to become single, arranging on the alignment film a first polymerizable liquid crystal layer including a polymerizable liquid crystal compound and a peeling preventive agent, and subsequently allowing the polymerizable liquid crystal compound to align in a direction of alignment treatment of the alignment film, and immobilizing alignment of the polymerizable liquid crystal compound by irradiation with light, and subsequently arranging on the first polymerizable liquid crystal layer a second polymerizable liquid crystal layer including a polymerizable liquid crystal compound and a peeling preventive agent so as to be 0.4 times to 10.0 times on the basis of a thickness of the first polymerizable liquid crystal layer, and allowing the second polymerizable liquid crystal compound to align in a direction identical with the direction of the first polymerizable liquid crystal layer to immobilize alignment of the polymerizable compound by irradiation with light using a photomask, and removing a light-unirradiated part of the second polymerizable liquid crystal layer by using a solvent or by heating to be immobilized in a state of an isotropic phase.

The invention also concerns use as a peeling preventive agent to a patterned retarder for a three-dimensional image display apparatus.

The invention further concerns a method for preventing peeling of a patterned retarder for a three-dimensional image display apparatus by use of the peeling preventive agent.

### Advantageous Effects of Invention

When a peeling preventive agent including a polymerizable compound having a polar group, and a polymer having a polar group is added to a polymerizable liquid crystal compound, a patterned retarder is obtained in which adhesion between polymerizable liquid crystal layer 303, and alignment film 302 subjected to patterned alignment treatment and formed on transparent support substrate 301 is improved, and thus productivity of a three-dimensional image display apparatus using the patterned retarder is improved.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 shows an example of a three-dimensional image display apparatus using a patterned retarder taking a state in which a polymerizable liquid crystal layer has an identical thickness, and different alignment directions with each other in adjacent regions according to the invention.

FIG. 2 shows an example of a three-dimensional image display apparatus using a patterned retarder taking a state in which one of polymerizable liquid crystal layers in adjacent regions is cured in a an isotropic phase in which a liquid crystal phase disappears according to the invention.

FIG. 3 is a schematic view showing a patterned retarder taking a state in which a polymerizable liquid crystal layer has an identical thickness, and different alignment directions with each other in adjacent regions according to the invention.

FIG. 4 is a schematic view showing a patterned retarder taking a state in which one of polymerizable liquid crystal layers in adjacent regions is cured in a an isotropic phase in which a liquid crystal phase disappears according to the invention.

### REFERENCE SIGNS LIST

101: Three-dimensional image display apparatus.
102: Polarization direction of emitted light.
103: Patterned retarder (¼λ plate subjected to patterned treatment).
104: Direction of alignment of liquid crystals in the patterned retarder.
105: Schematic diagram in a state of circularly polarized light as obtained by passing through the patterned retarder.
106: Circularly polarized light glasses.
107: Images separated into a right-eye use and a left-eye use by using polarized light glasses.
201: Patterned retarder (½λ plate prepared using a second polymerizable liquid crystal layer and subjected to patterned treatment).
202: Direction of alignment of liquid crystals in the patterned retarder.
203: State of linearly polarized light as obtained by passing through the patterned retarder.
204: First polymerizable liquid crystal layer.
205: Direction of alignment of liquid crystals in the first polymerizable liquid crystal layer.
206: Region obtained by curing the second polymerizable liquid crystal layer in an isotropic phase or removing the layer with a solvent.
301: Transparent support substrate.
302: Alignment film subjected to patterned alignment treatment.
303: Polymerizable liquid crystal layer.
401: Alignment film subjected to single alignment treatment.
402: First polymerizable liquid crystal layer.
403: Direction of alignment of the first polymerizable liquid crystal layer.
404: Second polymerizable liquid crystal layer.
405: Direction of alignment of the second polymerizable liquid crystal layer.
406: Region obtained by curing the second polymerizable liquid crystal layer in an isotropic phase or removing the layer with a solvent.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Usage of terms herein is as described below.

Transparent support substrate 301 is a generic term for glass or a plastic film for optical use. A liquid crystal compound is a generic term for a compound having a liquid crystal phase, and a compound having no liquid crystal phase but being useful as a component of a liquid crystal composition. The liquid crystal phase includes a nematic phase, a smectic phase and a cholesteric phase, and means the nematic phase in many cases. If a temperature of the liquid crystal phase is increased to a level higher than a specified temperature range, a liquid crystal state (anisotropy) of the liquid crystal phase disappears, and is changed into a liquid state. The liquid state is in a state of an isotropic phase. Polymerizability means a capability of polymerizing a monomer by a means such as light, heat or a catalyst to yield a polymer. A compound represented by formula (M1) or formula (M2) may be occasionally described as compound (M1) or compound] (M2). A same rule applies to any other compound represented by any other formula. (Meth)acrylate represents any one of or both of acrylate and methacrylate. In a chemical formula, a substituent of a benzene ring when a bonding hand is expressed without bonding to any of carbon atoms constituting the benzene ring represents that a bonding position of the bonding hand is arbitrary.

In the invention, a polymerizable liquid crystal compound is a generic term for the polymerizable liquid crystal compound alone in use or the group of compounds in combined use with a plurality of kinds. In order to facilitate clear description of a ratio of the polymerizable liquid crystal compounds, an explanation is made as a system without including a solvent for convenience. Then, a solution containing the polymerizable liquid crystal compound and the solvent is described as the solution of the polymerizable liquid crystal compound. When a solvent is included, the solution of the polymerizable liquid crystal compound is prepared by dissolving each component of the polymerizable liquid crystal compound into the solvent.

Alignment in the polymerizable liquid crystal compound is classified, based on magnitude of a tilt angle of liquid crystal molecules, or the like, into homogeneous alignment, homeotropic alignment, tilted alignment, twisted alignment and so forth. The tilt angle represents an angle of an incline between a support substrate and an alignment state of the polymerizable liquid crystal compound. “Homogeneous” means a state in which the alignment state is in parallel to the substrate, and aligned in one direction. Examples of the tilt angles in the homogeneous alignment include 0 degrees to 5 degrees. “Homeotropic” means a state in which the alignment state is perpendicular to the substrate. Examples of the tilt angles in the homeotropic alignment include 85 degrees to 90 degree. “Tilted” means a state in which the alignment state rises up perpendicularly from parallel as the alignment state is further separated from the substrate. Examples of the tilt angles in the tilted alignment include 5 degrees to 85 degrees. “Twisted” means a state in which the alignment state is in parallel to the substrate, but twisted stepwise on a helical axis. Examples of the tilt angles in the twisted alignment include 0 degrees to 5 degrees.

A peeling preventive agent is a generic term for a polymerizable compound having a polar group or a polymer having a polar group for preventing peeling between the polymerizable liquid crystal compound, and an alignment film subjected to patterned alignment treatment.

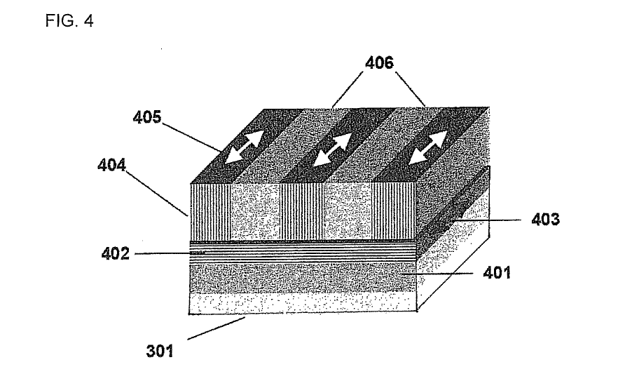

“Patterned” with regard to alignment of liquid crystal molecules represents, according to the invention, a state in which a polymerizable liquid crystal layer has an identical thickness, and different alignment directions with each other in adjacent regions, a state in which one of polymerizable liquid crystal layers in adjacent regions are removed using a solvent or the like (see FIG. 3), or a state in which the polymerizable liquid crystal layer is cured in a state of the isotropic state in which the liquid crystal phase is allowed to disappear (see FIG. 4).

The invention is constituted of item 1 and item 2 described above, and items 3 to 10 below.

Item 3. The three-dimensional image display apparatus according to any one of items 1 or 2, wherein the peeling preventive agent is a polymerizable compound having a polymerizable group, and having as a polar group at least any one of a hydroxyl group, a carboxyl group, a phosphate group, a sulfonate group, an amino group, a mercapto group and an isocyanate group, or the peeling preventive agent is a polymer having as a polar group at least any one of a hydroxyl group, a carboxyl group, a phosphate group, a sulfonate group, an amino group, a mercapto group and an isocyanate group.

Item 4. The three-dimensional image display apparatus according to any one of items 1 to 3, including one kind or two or more kinds of peeling preventive agents in an amount of 0.1 to 20% by weight based on the total weight of the polymerizable liquid crystal compound.

Item 5. The three-dimensional image display apparatus according to any one of items 1 to 4, wherein, as a method for controlling a direction of alignment of liquid crystal molecules, any one of a rubbing method, a photoalignment treatment method, a nanoimprinting method and a stretching method is applied.

Item 6. The three-dimensional image display apparatus according to any one of items 1 to 5, wherein the peeling preventive agent is a polymerizable compound having as a polymerizable group any one of an acryloyloxy group and a methacryloyloxy group.

Item 7. The three-dimensional image display apparatus according to any one of items 1 to 6, using a liquid crystal display device.

Item 8. Use as a peeling preventive agent to a patterned retarder for a three-dimensional image display apparatus, wherein the peeling preventive agent is a polymerizable compound having a polymerizable group, and having as a polar group any one of a hydroxyl group, a carboxyl group, a phosphate group, a sulfonate group, an amino group, a mercapto group and an isocyanate group, or the peeling preventive agent is a polymer having as a polar group at least any one of a hydroxyl group, a carboxyl group, a phosphate group, a sulfonate group, an amino group, a mercapto group and an isocyanate group.

Item 9. A method for preventing peeling of a patterned retarder for a three-dimensional image display apparatus by use of the peeling preventive agent according to item 8.

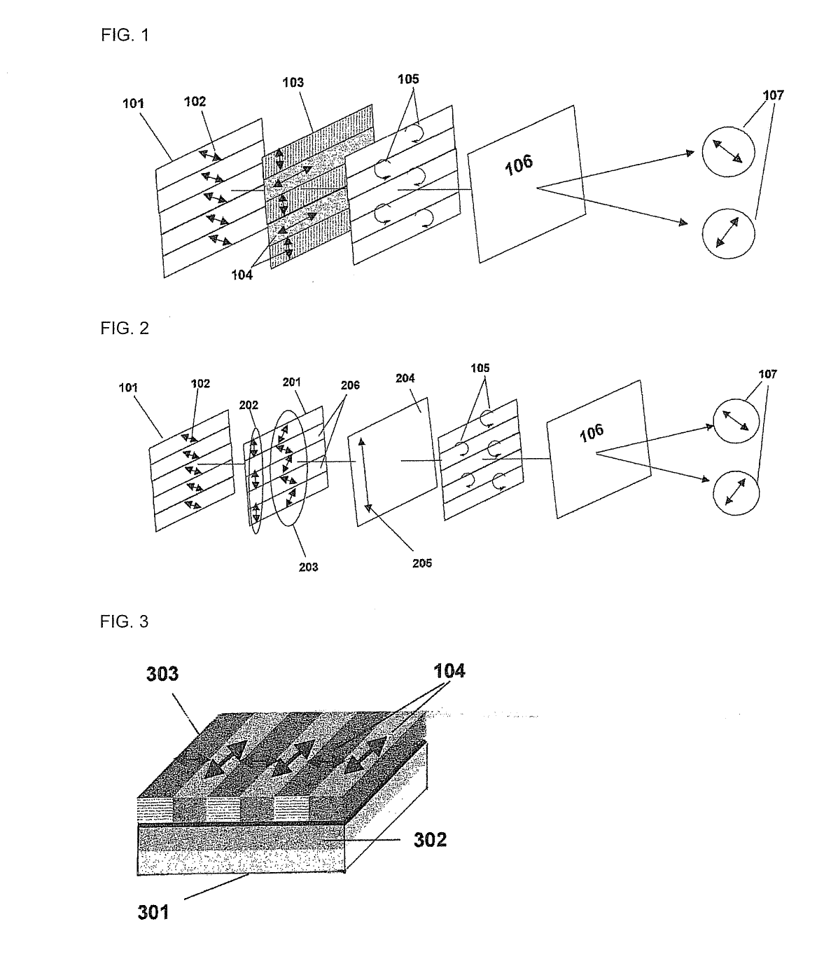

The three-dimensional image display apparatus in the invention is constituted by using, as shown in FIG. 1 or FIG. 2, patterned retarder 103 or patterned retarder 201. FIG. 3 is a schematic view showing a patterned retarder using a state in which polymerizable liquid crystal layer 303 has an identical thickness, and different alignment directions with each other in adjacent regions. FIG. 4 is a schematic view showing a patterned retarder using a state in which one of adjacent polymerizable liquid crystal layers is cured in an isotropic phase.

Patterned retarder 103 shown in FIG. 3 can be obtained by pretreating alignment film 302 as described below. Specific examples of methods for creating a state in which polymerizable liquid crystal layer 303 has the identical thickness, and the different alignment directions with each other in the adjacent regions include a rubbing method, a photoalignment method and a nanoimprinting method. In the rubbing method, alignment film 302 of polyimide, polyvinyl alcohol or the like is formed on transparent support substrate 301, and then rubbing treatment is first applied to a whole region, and next rubbing is performed in a direction different from the direction of first rubbing in a state in which a mask is arranged on alignment film 302. Alternatively, the method described in WO 2011/049326 A is exemplified.

When the photoalignment method is applied, photoalignment film 302 having a area being reactive with ultraviolet light is formed on transparent support substrate 301, and the photoalignment film is irradiated with polarized ultraviolet light using a photomask. Next, the photomask is moved, and a part unirradiated with polarized ultraviolet light is irradiated with polarized ultraviolet light in a polarization axis that is in a direction different from the direction of first polarized ultraviolet light. Alternatively, the method described in JP 2012-14064 A is exemplified. When a polymerizable liquid crystal compound is allowed to apply onto the alignment film subjected to such pretreatment, and perform heating and photocure, patterned retarder 103 in FIG. 1 is obtained.

Alternatively, in the nanoimprinting method, a specific example includes a method for directly pressing a mold onto the polymerizable liquid crystal layer. A specific example includes a method for pressing the mold onto an aligned polymerizable liquid crystal layer, such as the method described in Journal of Nanoscience and Nanotechnology Vol. 8 p. 4775-4778 (2008). Moreover, the method described in JP 2012-198325 A is also exemplified.

With regard to the patterned retarder shown in FIG. 4, alignment film 401 is formed on transparent support substrate 301, and then subjected to rubbing treatment, photoalignment treatment or nanoimprinting treatment to allow a polymerizable liquid crystal compound to coat, heat and photocure thereon, and thus first polymerizable liquid crystal layer 402 is formed. Here, an optical film subjected to stretching treatment may also be used in place of first polymerizable liquid crystal layer 402 and alignment film 401. Next, second polymerizable liquid crystal layer 404 is coated onto first polymerizable liquid crystal layer 402 or a first optical film subjected to stretching treatment, directly or through the alignment film. Then, patterned retarder 201 is obtained by allowing partial photocure using a photomask to remove an uncured part using a solvent or to heat and cure the uncured part by means of light or heat in an isotropic phase state. A specific example includes the method described in SID 2008 DIGEST p. 260-263.

The peeling preventive agent is a compound having one kind or two or more kinds of polymerizable groups, and having as a polar group apart from the polymerizable group any one of a hydroxyl group, a carboxyl group, a phosphate group, a sulfonate group, an amino group, a mercapto group or an isocyanate group. The compounds interact with the polar group of the alignment layer. A mechanism of interaction may be variously conceived, but a hydrogen bond and intermolecular interaction are conceived to play a central role. Adhesion force between the peeling preventive agent and the alignment film is promoted by such interaction, and the polymerizable liquid crystal compound and the peeling preventive agent are copolymerized, and thus the adhesion as the patterned retarder is ensured. Furthermore, when the peeling preventive agent is the polymer having the polar group, the polar group of the peeling preventive agent interacts with the polar group of the alignment film, but the adhesion is conceived to be ensured, when the polymer of the polymerizable liquid crystal compound and the polymer of the alignment layer are compatibilized.

The peeling preventive agent is preferably added in the range of approximately 0.1 to approximately 20% by weight, further preferably, in the range of approximately 0.5 to approximately 15% by weight, still further preferably, in the range of approximately 1 to approximately 10% by weight, based on the total weight of the polymerizable liquid crystal compound.

Specific examples of the peeling preventive agents include compounds each having a hydroxyl group below, and may also be a commercial item.

Specific examples include butanediol monoacrylate, a reaction product between butyl glycidyl ether and (meth)acrylic acid (DENACOL (registered trademark) DA-151, made by Nagase & Co., Ltd.), 3-chloro-2-hydroxypropyl methacrylate and glycerol methacrylate (BLEMMER (registered trademark) GLM, made by NOF Corporation), glycerol acrylate and glycerol dimethacrylate (BLEMMER GMR series, made by NOF Corporation), glycerol triacrylate (EX-314, made by Nagase ChemteX Corporation), 2-hydroxyethyl acrylate (BHEA, made by Nippon Shokubai Co., Ltd.), 2-hydroxyethyl methacrylate (HEMA, made by Nippon Shokubai Co., Ltd.), 2-hydroxypropyl acrylate (HPMA, made by Nippon Shokubai Co., Ltd.), 2-hydroxypropyl methacrylate (HPMA, made by Nippon Shokubai Co., Ltd.), caprolactone-modified 2-hydroxyethyl acrylate, caprolactone-modified 2-hydroxyethyl methacrylate and phenoxyhydroxypropyl acrylate (M-600A, made by Kyoeisha Chemical Co., Ltd.), 2-hydroxy-3-acryloyloxypropyl methacrylate (G-201P, made by Kyoeisha Chemical Co., Ltd.), KAYARAD (registered trademark) R-167, made by Nippon Kayaku Co., Ltd., 4-(6-acryloyloxy-n-hexy-1-yloxy)phenol (ST03456, made by Synthon Chemicals GmbH & Co. KG), pentaerythritol tri(meth)acrylate, dipentaerythritolmonohydroxy penta(meth)acrylate and triglycerol diacrylate (Epoxy Ester 80MFA, made by Kyoeisha Chemical Co., Ltd.).

Specific examples of polyethylene glycol monomethacrylate having a polymerization degree of 2 to 20 include, as exemplified by formula (A-1) below, BLEMMER PE-90 (n=2), PE-200 (n=4.5) and PE-350 (n=8), made by NOF Corporation. Here, the polymerization degree of polyethylene glycol monomethacrylate is further preferably 2 to 10. Moreover, n represents the mean constituent unit number in the description below.

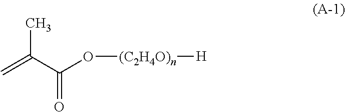

Specific examples of polyethylene glycol monoacrylate having a polymerization degree of 2 to 20 include, as exemplified by formula (A-2) below, BLEMMER AE-90 (n=2), AE-200 (n=4.5) and AE-400 (n=10), made by NOF Corporation. Here, the polymerization degree of polyethylene glycol monoacrylate is further preferably 2 to 10.

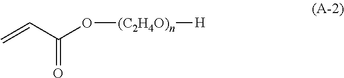

Specific examples of polypropylene glycol monomethacrylate having a polymerization degree of 2 to 20 include, as exemplified by formula (A-3) below, BLEMMER PP-1000 (n=4 to 6), PP-500 (n=9) and PP-800 (n=13), made by NOF Corporation. Here, the polymerization degree of polypropylene glycol monomethacrylate is further preferably 3 to 13.

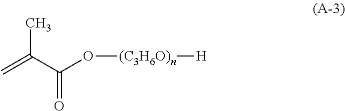

Specific examples of polypropylene glycol monoacrylate having a polymerization degree of 2 to 20 include, as exemplified by formula (A-4) below, BLEMMER AP-150 (n=3), AP-400 (n=6), AP-550 (n=9) and AP-800 (n=13), made by NOF Corporation. Here, the polymerization degree of polypropylene glycol monoacrylate is further preferably 3 to 13.

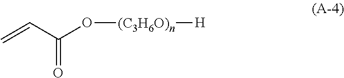

A specific example of poly(ethylene glycol-propylene glycol)monomethacrylate includes, as exemplified by formula (A-5) below, BLEMMER 50PEP-300, made by NOF Corporation. Here, ethyleneoxy or propyleneoxy that means R is incorporated by random copolymerization. The mean constituent unit number (m) of ethyleneoxy and propyleneoxy is 2.5 and 3.5, respectively.

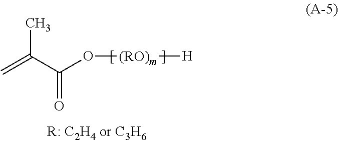

A specific example of polyethylene glycol-polypropylene glycol monomethacrylate includes, as exemplified by formula (A-6) below, BLEMMER 70PEP-350B (m=5, n=2), made by NOF Corporation.

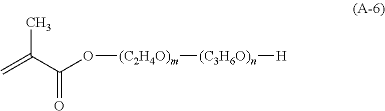

Specific examples of polyethylene glycol-polypropylene glycol monoacrylate include BLEMMER AEP series.

Specific examples of poly(ethylene glycol-tetramethylene glycol)monomethacrylate include, as exemplified by formula (A-7) below, BLEMMER 55PET-400, 30PET-800 and 55PET-800, made by NOF Corporation. Here, the polymerization degree further preferably 2 to 10. In the formula, ethyleneoxy or butyleneoxy that means R is incorporated by random copolymerization. The mean constituent unit number (m) of ethyleneoxy and butyleneoxy is 5 and 2 in 55PET-400, 6 and 10 in 30PET-800, and 10 and 5 in 55PET-800, respectively.

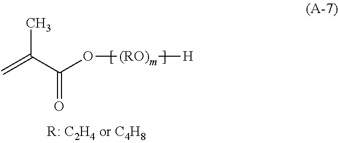

Specific examples of poly(ethylene glycol-tetramethylene glycol)monoacrylate include BLEMMER AET series, made by NOF Corporation.

Specific examples of polypropylene glycol-tetramethylene glycol)monomethacrylate include, as exemplified by formula (A-8) below, BLEMMER 30PPT-800, 50PPT-800 and 70PPT-800, made by NOF Corporation. Here, the polymerization degree is further preferably 3 to 10. In the formula, propyleneoxy or butyleneoxy that means R is incorporated by random copolymerization. The mean constituent unit number (m) of propyleneoxy and butyleneoxy is 4 and 8 in 30PPT-800, 7 and 6 in 50PPT-800, and 10 and 3 in 70PPT-800, respectively.

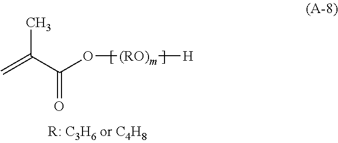

Specific examples of poly(propylene glycol-tetramethylene glycol)monoacrylate include BLEMMER APT series, made by NOF Corporation.

Specific examples of propylene glycol polybutylene glycol mono(meth)acrylate include BLEMMER 10PPB-500B (n=6), made by NOF Corporation, as exemplified by formula (A-9) below, and 10APB-500B (n=6) as exemplified by formula (A-10) below. Here, the polymerization degree is further preferably 6.

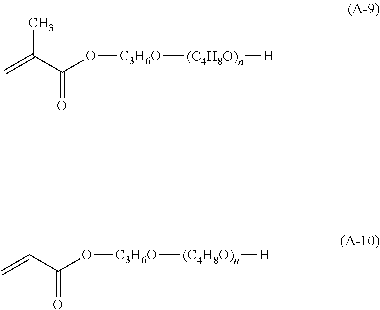

Specific examples of compounds each having a carboxyl group are as described below, and may also be a commercial item.

Specific examples include 2-methacryloyloxyethyl succinate (LIGHT ESTER HO-MS(N), made by Kyoeisha Chemical Co., Ltd.), 2-methacryloyloxyethyl hexahydrophthalate (LIGHT ESTER HO-HH(N), made by Kyoeisha Chemical Co., Ltd.), 2-acryloyloxyethyl succinate (LIGHT ACRYLATE HOA-MS (N), made by Kyoeisha Chemical Co., Ltd.), 2-acryloyloxyethyl hexahydrophthalate (LIGHT ACRYLATE HOA-HH(N), made by Kyoeisha Chemical Co., Ltd.), 2-acryloyloxyethyl phthalate (LIGHT ACRYLATE HOA-MPL(N), made by Kyoeisha Chemical Co., Ltd.), 2-acryloyloxyethyl-2-hydroxyethyl-phthalate (LIGHT ACRYLATE HOA-MPE(N), made by Kyoeisha Chemical Co., Ltd.), 4-(2-acryloyloxyethyl-1-yloxy)benzoic acid (ST01630, made by Synthon Chemicals GmbH & Co. KG), 4-(3-acryloyloxy-n-prop-1-yloxy)benzoic acid (ST02453, made by Synthon Chemicals GmbH & Co. KG), 4-(2-methacryloyloxyethyl-1-yloxy)benzoic acid (ST01889, made by Synthon Chemicals GmbH & Co. KG), 4-(4-acryloyloxy-n-buty-1-yloxy)benzoic acid (ST01680, made by Synthon Chemicals GmbH & Co. KG), 4-(6-acryloyloxy-n-hexy-1-yloxy)benzoic acid (ST00902, made by Synthon Chemicals GmbH & Co. KG), 4-(6-acryloyloxy-n-hexy-1-yloxy)-2-methylbenzoic acid (ST03606, made by Synthon Chemicals GmbH & Co. KG), 4-(6-methacryloyloxy-n-hexy-1-yloxy)benzoic acid (ST01618, made by Synthon Chemicals GmbH & Co. KG) and 4-(10-acryloyloxy-n-deci-1-yloxy)benzoic acid (ST03604, made by Synthon Chemicals GmbH & Co. KG).

Specific examples of compounds each having a phosphate group are as described below, and may also be a commercial item.

Specific examples include 2-acryloyloxyethyl acid phosphate (LIGHT ACRYLATE P-1A(N), made by Kyoeisha Chemical Co., Ltd.), 2-methacryloyloxyethyl acid phosphate (LIGHT ESTER P-1M), made by Kyoeisha Chemical Co., Ltd.), LIGHT ESTER P-2M, made by Kyoeisha Chemical Co., Ltd. and KAYAMER (registered trademark) PM-2, made by Nippon Kayaku Co., Ltd.

Specific examples of the compounds each having an isocyanate group are as described below, and may also be a commercial item.

Specific examples include 2-methacryloiloxyethyl isocyanate (KARENZ (registered trademark) MOI, made by Showa Denko K. K), 2-acryloyloxyethyl isocyanate (KARENZ AOI made by Showa Denko K. K), 1,1-(bisacryloyloxymethyl)ethyl isocyanate (KARENZ BEI, made by Showa Denko K. K), and KARENZ MOI-EG, made by Showa Denko K. K.

Specific examples of compounds each having an amino group are as described below, and may also be a commercial item.

Specific examples include an aminated acrylic polymer (POLYMENT (registered trademark) NK-350, NK-380, NK-100PM and NK-200PM, made by Nippon Shokubai Co., Ltd.)

A compound used as the polymerizable liquid crystal compound preferably includes a liquid crystal compound having one or two or more of polymerizable groups. The polymerizable liquid crystal compound used for the invention can be prepared by appropriately combining synthesis methods in organic chemistry, as described in Houben Wyle, Methoden der Organischen Chemie, Georg Thieme Verlag, Stuttgart), Organic Reactions, John Wily & Sons Inc.), Organic Syntheses, John Wily & Sons, Inc.), Comprehensive Organic Synthesis (Pergamon Press) and New Experimental Chemistry Course (Shin Jikken Kagaku Koza in Japanese) (Maruzen Co., Ltd.). Specific examples are described in JP 2011-148762 A, WO 93/22397 A, WO 95/22586 A, WO 97/00600 A, GB 2351734 B, DE 19504224 A and EP 0261712 A. The polymerizable liquid crystal compounds described in the literatures are listed as examples for illustrative purposes, and are not intended to limit the scope of the invention.

Specific examples of the polymerizable liquid crystal compounds are described as in formulas below for illustrative purposes only, and are not intended to limit the scope of the invention.

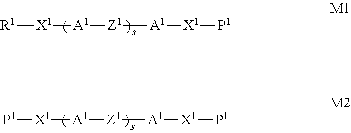

In formula (M1) and formula (M2),

P¹ is independently a polymerizable group, preferably, an acryloyloxy group, a methacryloyloxy group, a vinyl group, a vinyloxy group, a propenyl ether group, a glycidyl group, a glycidyl ether group, an oxetanyl group, an oxetanyl ether group, a maleimide group, a maleimide carboxyl group, a thiol group or a styryl group.

R¹ is independently hydrogen, fluorine, chlorine, —CN or alkyl having 1 to 20 carbons, and in the alkyl, at least one of —CH₂— may be replaced by —O—, —COO— or —OCO—, and at least one of hydrogen may be replaced by halogen.

A¹ is independently 1,4-cyclohexylene, 1,4-phenylene, pyridine-2,5-diyl, pyrimidine-2,5-diyl, naphthalene-2,6-diyl or fluorene-2,7-diyl, and at least one of hydrogen may be replaced by halogen, alkyl having 1 to 7 carbons, alkyl halide having 1 to 7 carbons, branched alkyl having 1 to 7 carbons, ester (—COOR^{a}; wherein R^{a} is straight-chain alkyl having 1 to 7 carbons) or acyl (—COR^{b}; wherein R^{b} is straight-chain alkyl having 1 to 15 carbons).

X¹ is independently a single bond or alkylene having 1 to 20 carbons, and at least one of —CH₂— in the alkylene may be replaced by —O—, —COO— or —OCO—.

Z¹ is independently a single bond, —COO—, —OCO—, —CH₂CH₂—, —CH═CH—, —C≡C—, —CH₂O—, —OCH₂—, —CF₂O—, —OCF₂—, —CH₂CH₂COO—, —OCOCH₂CH₂—, —CH═CHCOO— or —OCOCH═CH—.

Then, s is independently an integer from 1 to 5.

Specific examples are as described below.

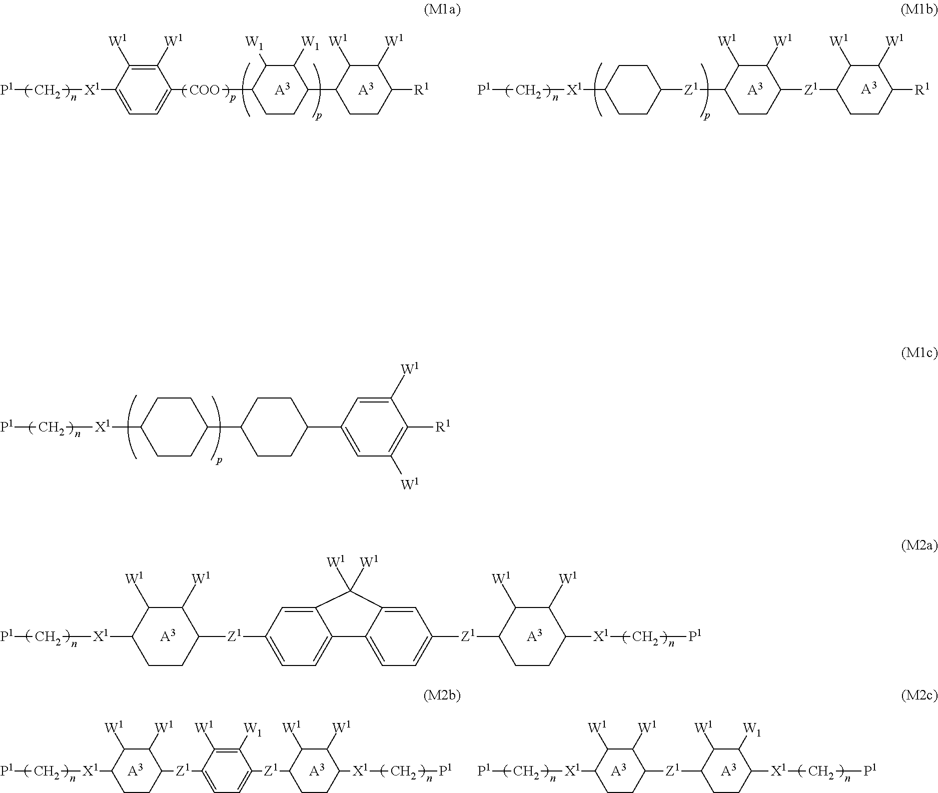

In formulas (M1a) to (M2c), P¹ is independently a polymerizable group, and an acryloyloxy group, a methacryloyloxy group, a vinyl group, a vinyloxy group, a propenyl ether group, a glycidyl group, a glycidyl ether group, an oxetanyl group, an oxetanyl ether group, a maleimide group, a maleimide carboxyl group, a thiol group or a styryl group, preferably, an acryloyloxy group, a methacryloyloxy group, a glycidyl group, a glycidyl ether group, an oxetanyl group or an oxetanyl ether group.

R¹ is independently hydrogen, fluorine, chlorine, —CN or alkyl having 1 to 20 carbons, and in the alkyl, at least one of —CH₂— may be replaced by —O—, —COO— or —OCO—, and at least one of hydrogen may be replaced by halogen.

Ring A³ is independently 1,4-cyclohexylene or 1,4-phenylene.

W¹ is independently halogen, straight-chain alkyl having 1 to 7 carbons, straight-chain alkoxy having 1 to 7 carbons, alkyl halide having 1 to 7 carbons, branched alkyl having 1 to 7 carbons, ester (—COOR^{a}; wherein R^{a} is straight-chain alkyl having 1 to 7 carbons), or acyl (—COR^{b}; wherein R^{b} is straight-chain alkyl having 1 to 15 carbons).

X¹ is independently a single bond or alkylene having 1 to 20 carbons, and at least one of —CH₂— in the alkylene may be replaced by —O—, —OCO— or —COO—.

Z¹ is independently —COO—, —OCO—, —CH₂CH₂—, —CH₂O—, —OCH₂—, —CH₂CH₂COO—, —OCOCH₂CH₂—, —CH═CHCOO— or —OCOCH═CH—.

Then, p and q are independently 0 or 1.

Then, n is independently an integer from 0 to 20.

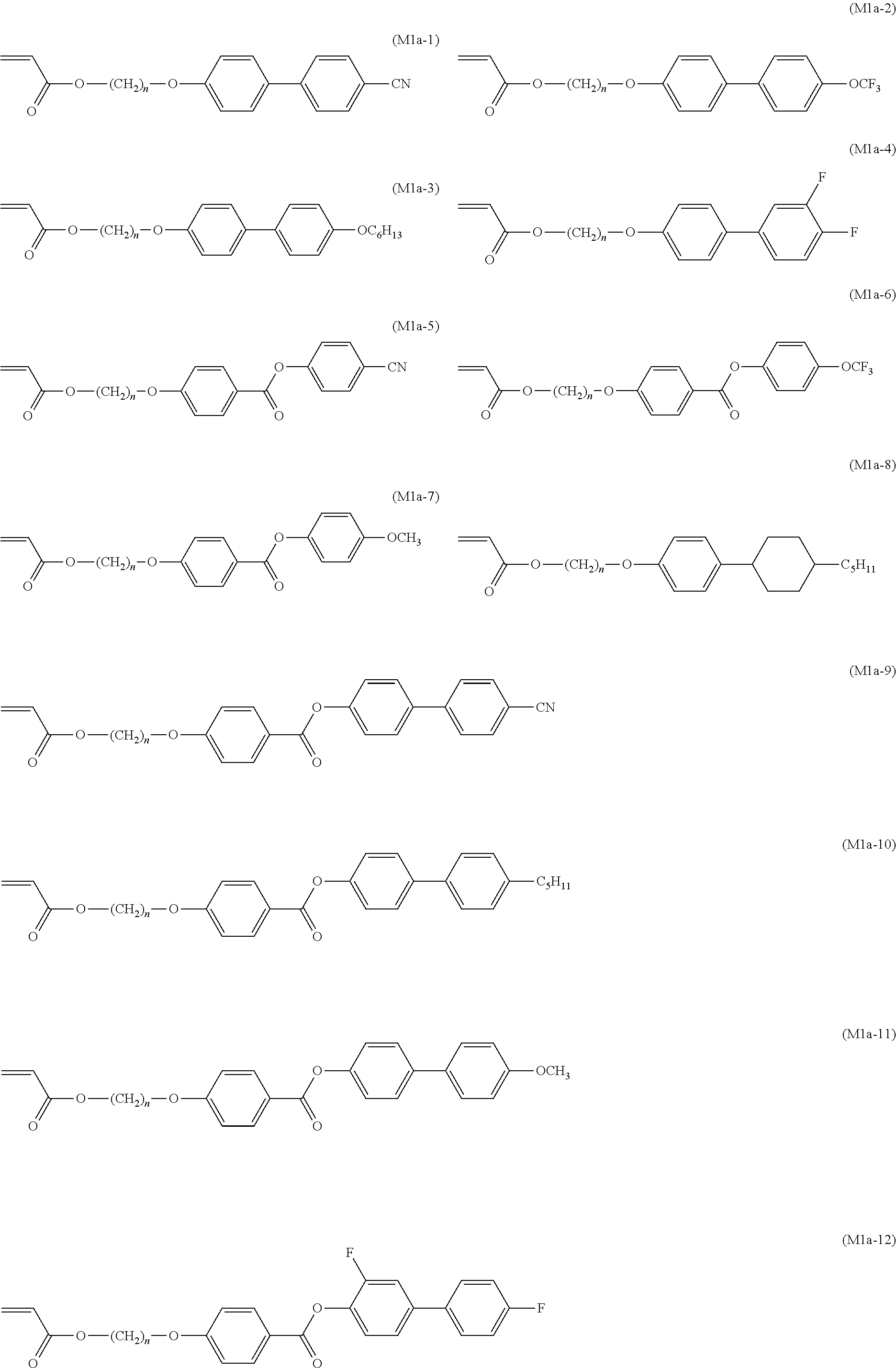

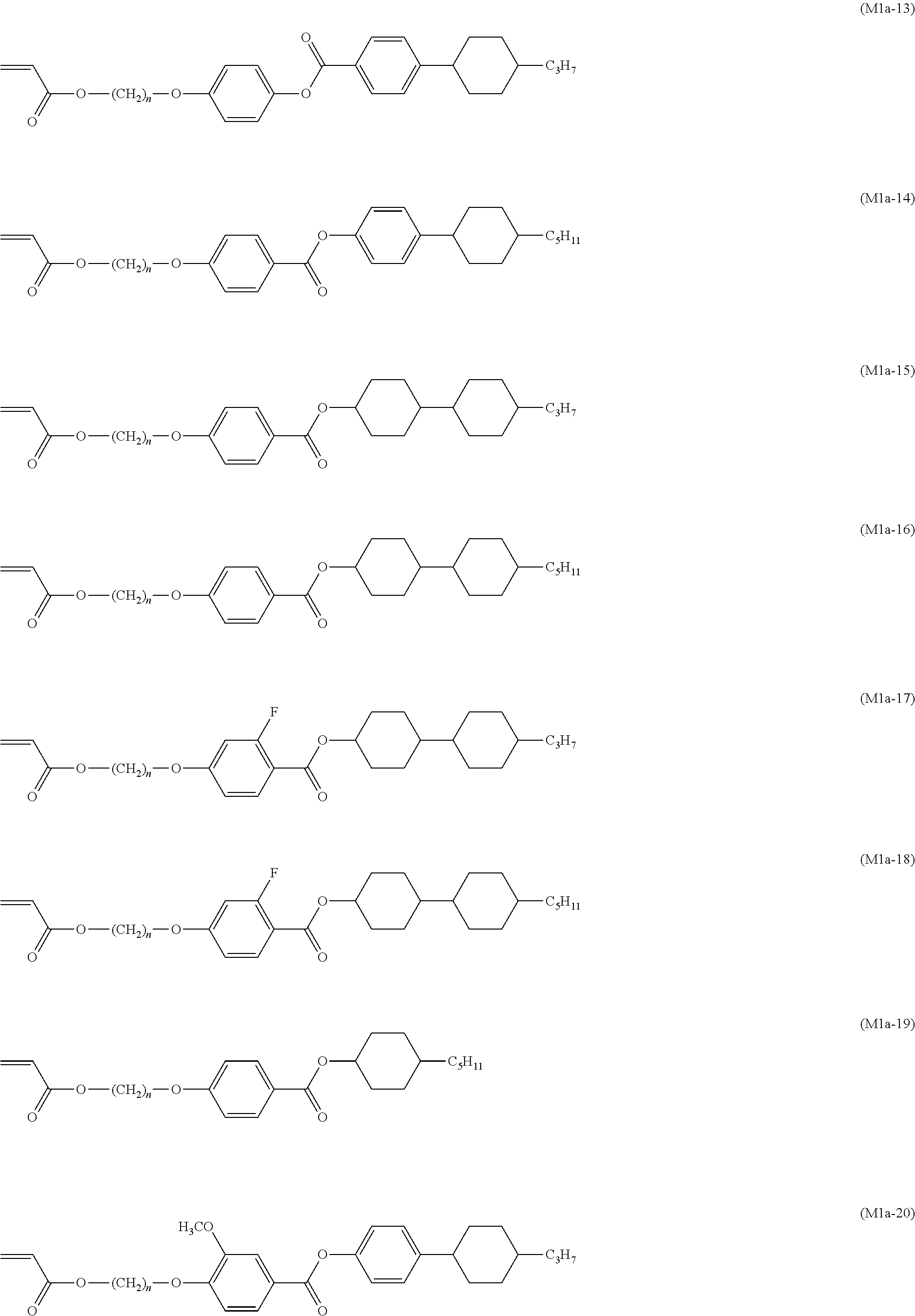

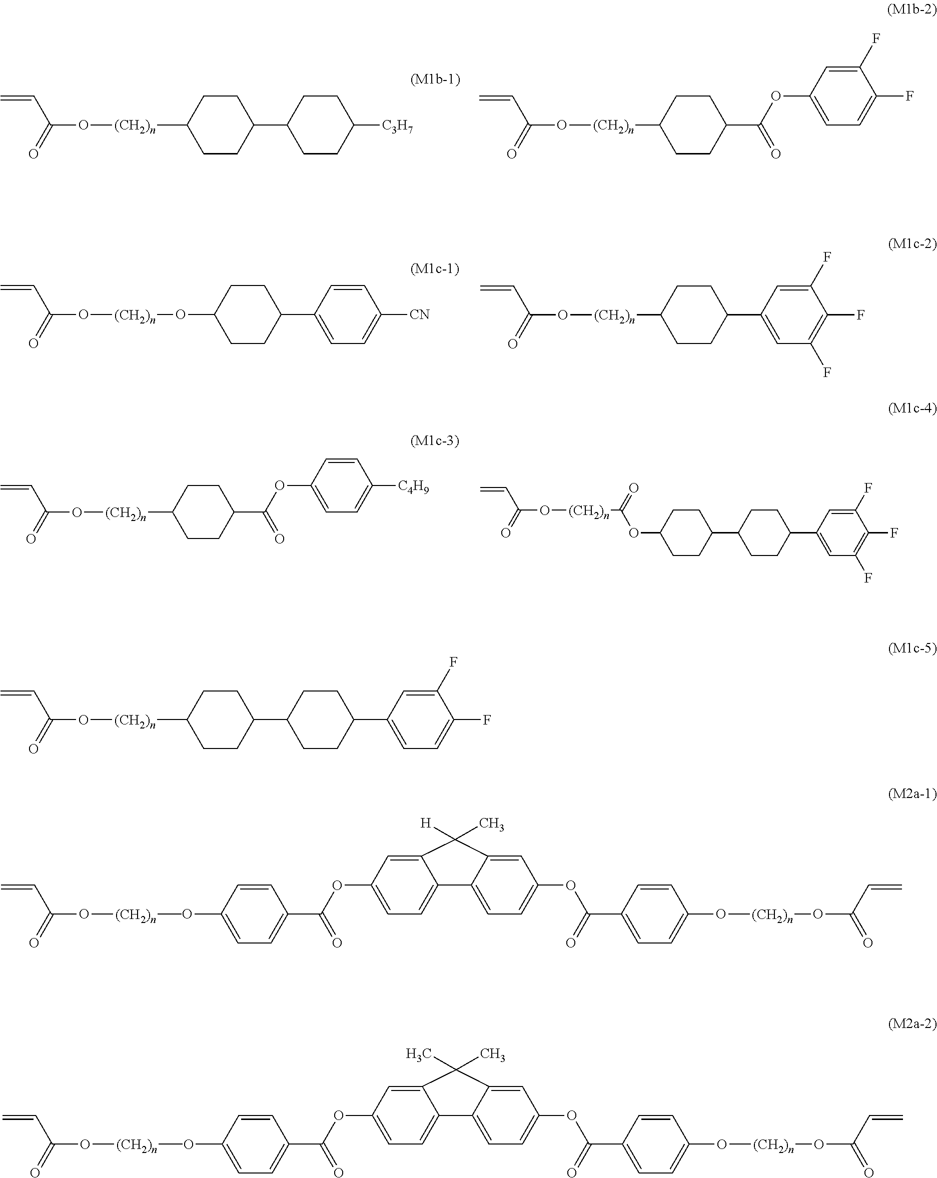

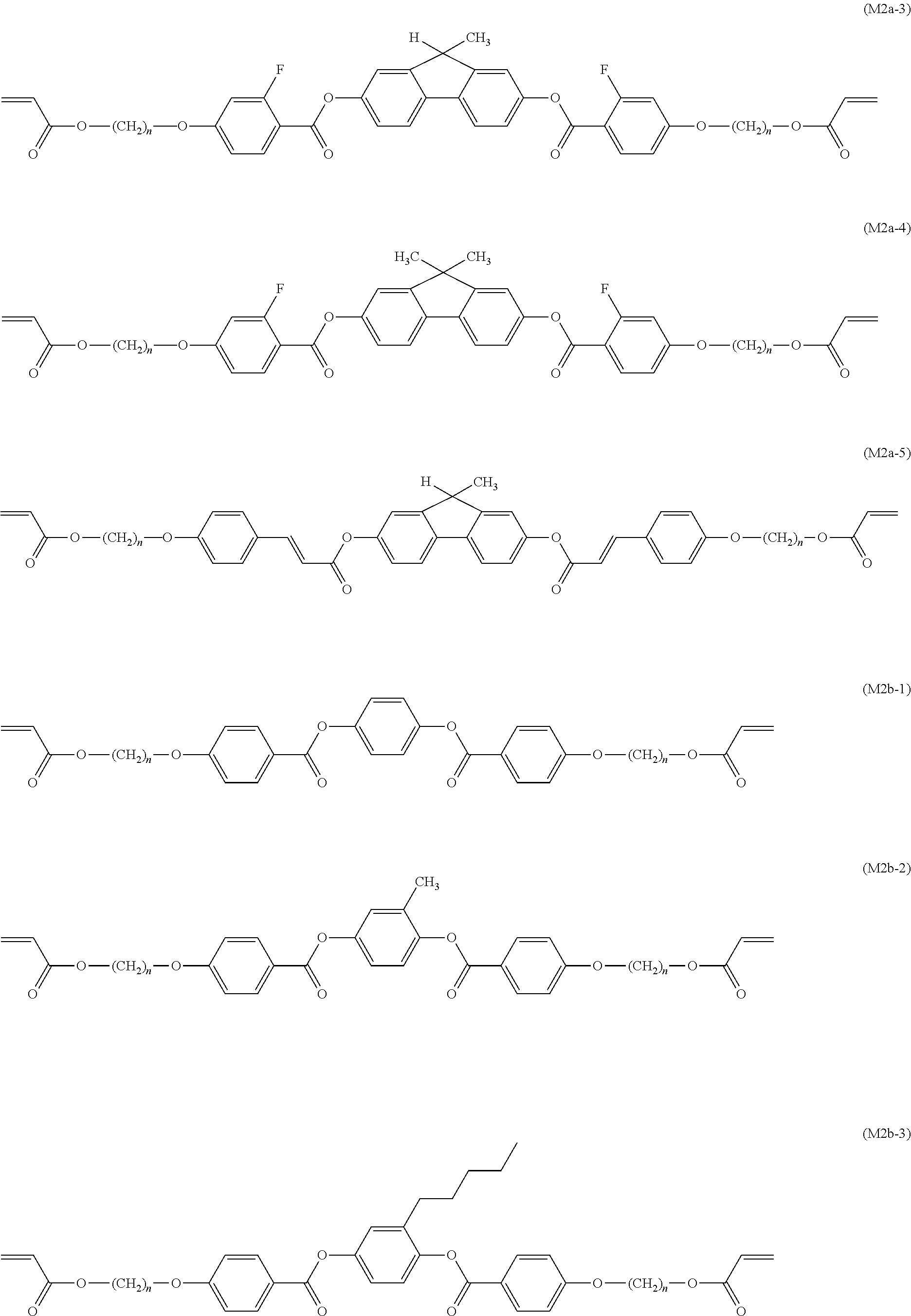

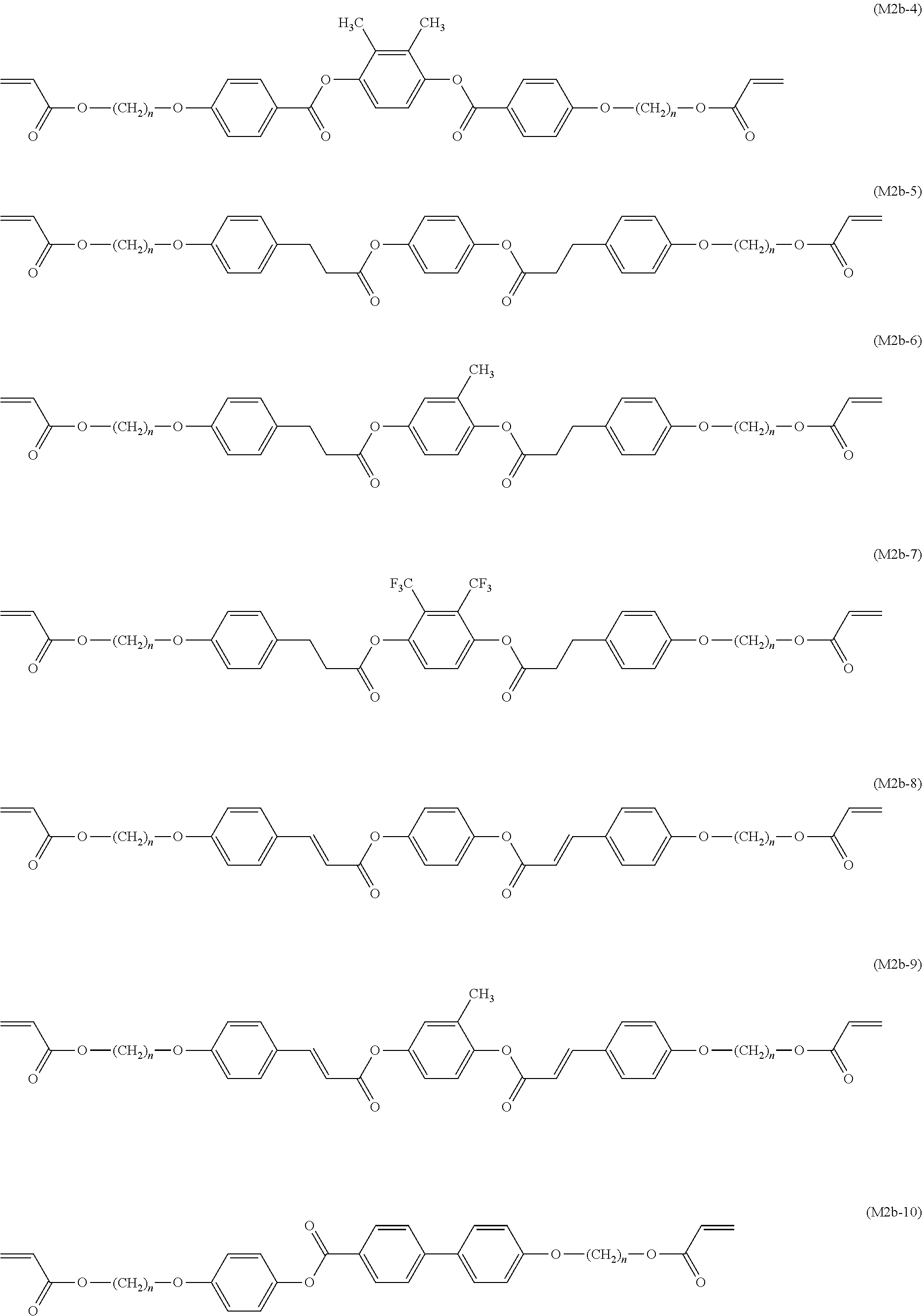

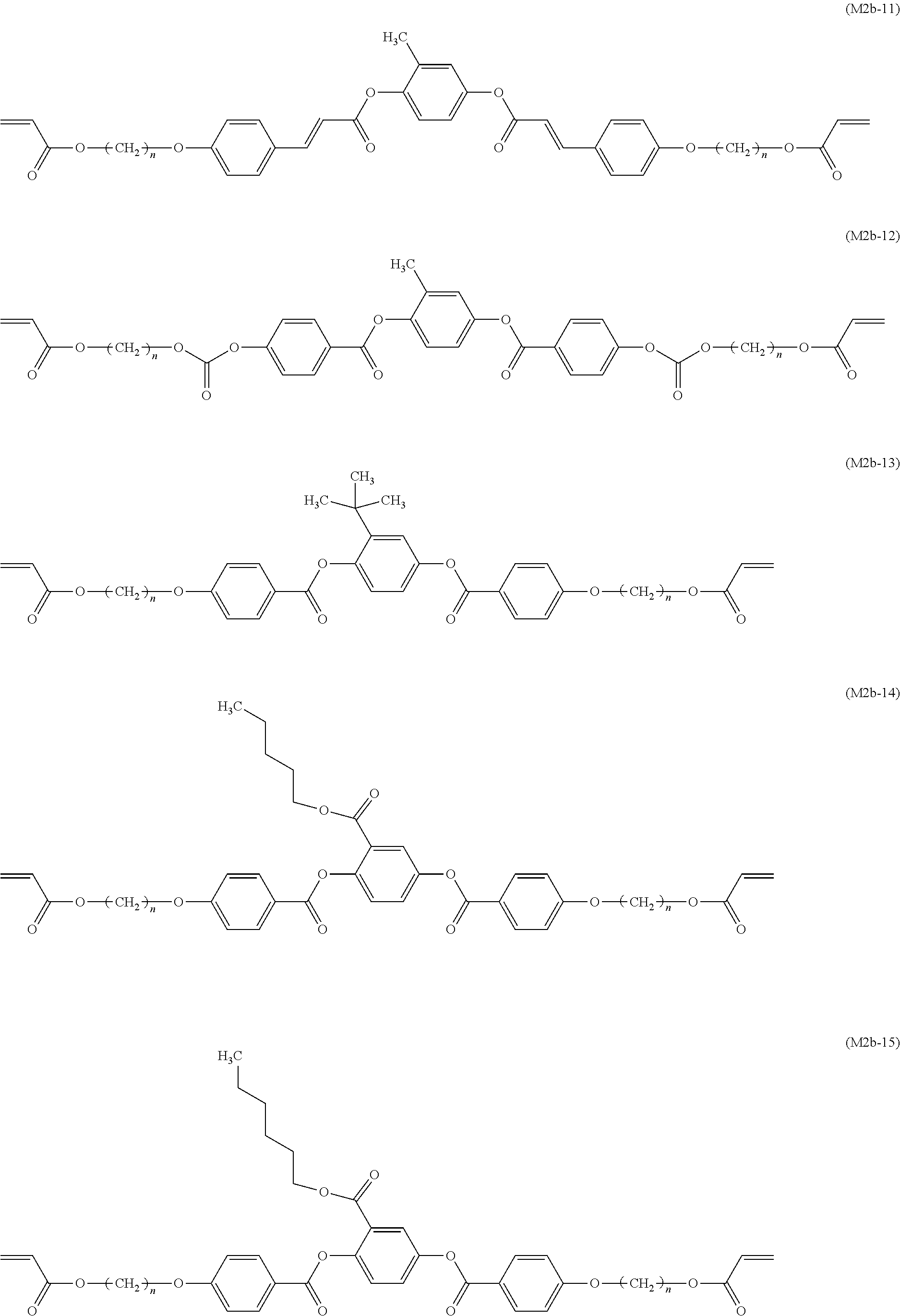

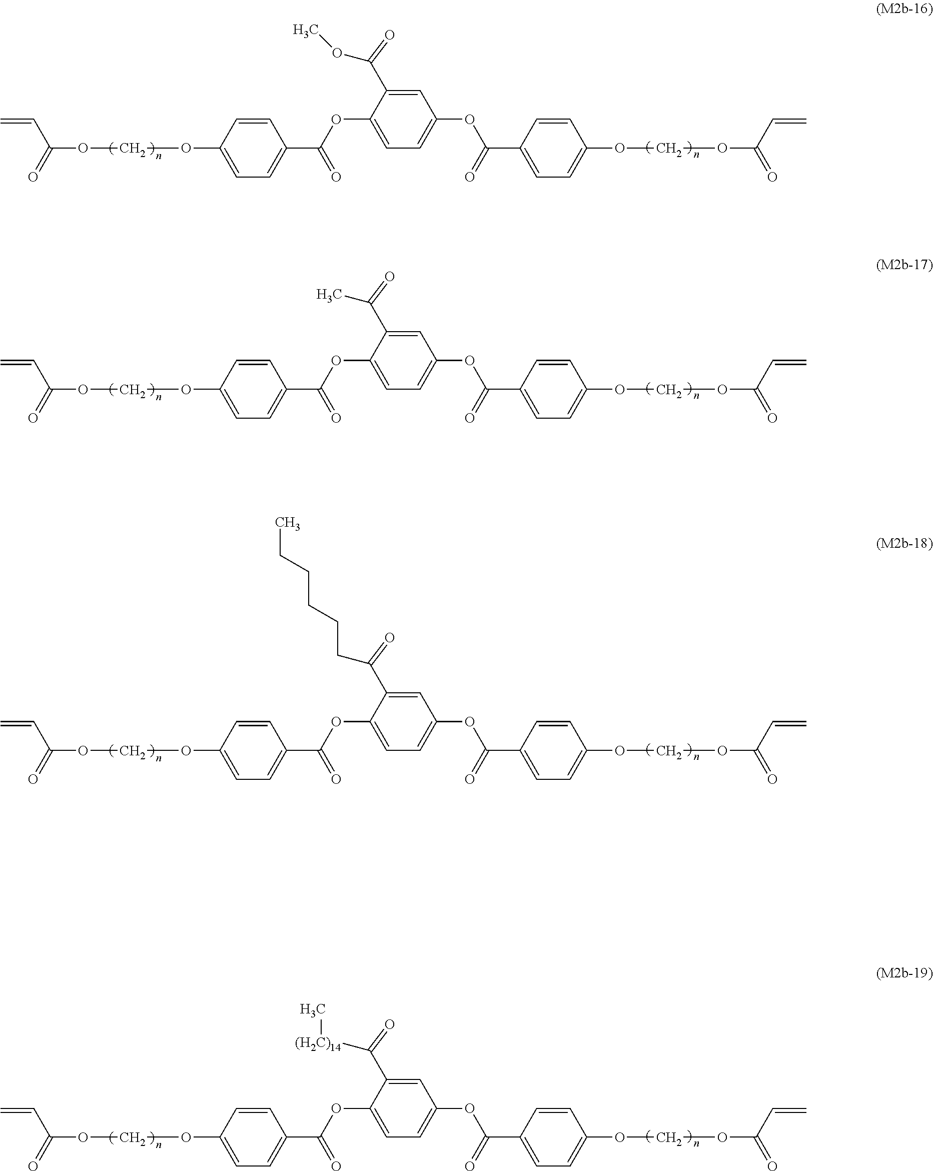

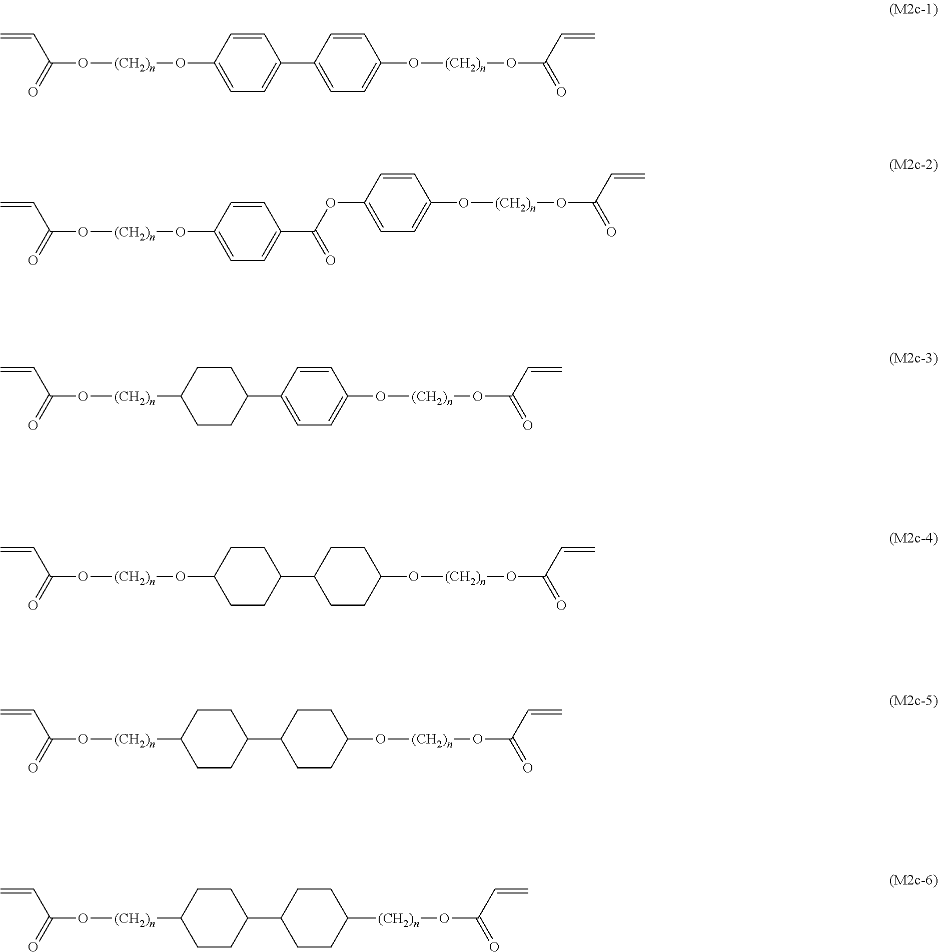

The polymerizable liquid crystal compound of the invention can contain an additive. Specific examples of the additives include a surfactant, a polymerization initiator, a photosensitizer, a light stabilizer, an ultraviolet light absorber, an antioxidant, a radical scavenger, a chain transfer agent, a coupling agent, a diluent, a reactive diluent, a thixotropic agent (rheology control agent), a coloring agent, a dye or any other auxiliary reagent.

The polymerizable liquid crystal compound of the invention may contain any other polymerizable compound different from the polymerizable liquid crystal compound. Specific examples of compounds each having one polymerizable group but without a polar group identical with the polar group of the peeling preventive agent include styrene, nucleus-substituted styrene, vinyl chloride, vinylidene chloride, N-vinyl-pyrrolidone, fatty acid vinyl ester (vinyl acetate), alkyl (meth)acrylate (the number of carbons of alkyl: 1 to 18), hydroxyalkyl (meth)acrylate (the number of carbons of hydroxyalkyl: 1 to 18), aminoalkyl (meth)acrylate (the number of carbons of aminoalkyl: 1 to 18), ether oxygen-containing alkyl (meth)acrylate (the number of carbons of ether oxygen-containing alkyl: 3 to 18, such as methoxyethyl ester, ethoxyethyl ester, methoxypropyl ester, methylcarbyl ester, ethylcarbyl ester and butylcarbyl ester). N-vinylacetamide, p-t-butyl-benzoic acid vinyl ester, N,N-dimethylaminobenzoic acid vinyl ester, vinyl benzoate, vinyl pivalate, 2,2-dimethylbutanoic acid vinyl ester, 2,2-dimethylpentanoic acid vinyl ester, 2-methyl-2-butanoic acid vinyl ester, vinyl propionate, vinyl stearate, 2-ethyl-2-methylbutanoic acid vinyl ester, dicyclopentanyloxylethyl (meth)acrylate, isobornyloxylethyl (meth)acrylate, isobornyl (meth)acrylate, adamanthyl (meth)acrylate, dimethyladamanthyl (meth)acrylate, dicyclopentanyl (meth)acrylate and dicyclopentenyl (meth)acrylate.

Specific examples of compounds each having two polymerizable groups but without a polar group identical with the polar group of the peeling preventive agent include 1,4-butanediol diacrylate, 1,6-hexanediol diacrylate, 1,9-nonanediol diacrylate, neopentyl glycol diacrylate, dimethyloltricyclodecane diacrylate, triethylene glycol diacrylate, dipropylene glycol diacrylate, tripropylene glycol diacrylate, tetraethylene glycol diacrylate, bisphenol A EO-added diacrylate, bisphenol A glycidyl diacrylate (BISCOAT V#700), polyethylene glycol diacrylate, and a methacrylate compound of the compounds described above. The compounds are suitable for further improving film-forming ability of the polymer.

Specific examples of compounds each having three or more polymerizable groups but without a polar group identical with the polar group of the peeling preventive agent include trimethylolpropane tri(meth)acrylate, trimethylol EO-added tri(meth)acrylate, tris(meth)acryloyloxyethyl phosphate, tris((meth)acryloyloxyethyl)isocyanurate, alkyl-modified dipentaerythritol tri(meth)acrylate, EO-modified trimethylolpropane tri(meth)acrylate, PO-modified trimethylolpropane tri(meth)acrylate, pentaerythritol tetra(meth)acrylate, alkyl-modified dipentaerythritol tetra(meth)acrylate, ditrimethylolpropane tetra(meth)acrylate, dipentaerythritol hexa(meth)acrylate, alkyl-modified dipentaerythritol penta(meth)acrylate, BISCOAT V#802 (the number of functional groups=8) and BISCOAT V#1000 (the number of functional groups=14 on average). “BISCOAT” is a trade name of products of Osaka Organic Chemical Industry Ltd. A compound having 16 or more functional groups can be obtained by using, as a raw material, Boltorn H20 (16 functions), Boltorn H30 (32 functions) and Boltorn H40 (64 functions), all being sold by Perstorp Specialty Chemicals AB, and acrylating the materials.

The polymerizable liquid crystal compound may contain a solvent that gives no damage to the transparent support substrate or the alignment layer, and can dissolve the polymerizable liquid crystal compound. The organic solvent is useful for forming a paint film having a uniform thickness. When the organic solvent is removed by heating, a paint film having a uniform thickness of the polymerizable liquid crystal compound can be obtained.

As the surfactant, various kinds of compounds can be used, such as a silicone-based, fluorine-based, polyether-based, acrylic acid copolymer-based or titanate-based compound, imidazoline, quaternary ammonium salt, alkylamine oxide, a polyamine derivative, a polyoxyethylene-polyoxypropylene condensate, polyethylene glycol and an ester thereof, sodium lauryl sulfate, ammonium lauryl sulfate, amine lauryl sulfates, alkyl-substituted aromatic sulfonate, alkyl phosphate, an aliphatic or aromatic sulfonic acid-formalin condensate, lauryl amide propylbetaine, lauryl aminoacetic acid betaine, polyethylene glycol fatty acid esters, polyoxyethylene alkylamine, perfluoroalkyl sulfonate, perfluoroalkyl carboxylate, an oligomer having a perfluoroalkyl group and a hydrophilic group, an oligomer having a perfluoroalkyl group and a lipohilic group, urethane having a perfluoroalkyl group, polyester-modified polydimethylsiloxane having a hydroxyl group, polyester polyether-modified polydimethylsiloxane having a hydroxyl group, polyether-modified polydimethylsiloxane having a hydroxyl group, and polyester-modified polyalkyl siloxane. The surfactant is effective in facilitating application of the polymerizable liquid crystal composition onto the transparent support substrate, or the like. A preferred ratio of the surfactant is, although the preferred range is different depending on kinds of surfactants and ratios of the polymerizable liquid crystal compositions, in the range of approximately 0.0001 to approximately 0.05, further preferably, in the range of approximately 0.001 to approximately 0.03 in a weight ratio, based on the total weight of the polymerizable liquid crystal compounds.

In order to optimize a rate of polymerization of the polymerizable liquid crystal composition, a publicly known photopolymerization initiator may be used. A preferred amount of addition of the photopolymerization initiator is in the range of approximately 0.0001 to approximately 0.20 in a weight ratio based on the total weight of the polymerizable liquid crystal compounds. A further preferred weight ratio is in the range of approximately 0.001 to approximately 0.15. A still preferred weight ratio is in the range of approximately 0.01 to approximately 0.15. Specific examples of the photopolymerization initiators include 2-hydroxy-2-methyl-1-phenylpropane-1-one (DAROCURE 1173), 1-hydroxycyclohexyl phenyl ketone, 2,2-dimethoxy-1,2-diphenylethane-1-one (IRGACURE 651), 1-hydroxy-cyclohexyl-phenyl-ketone (IRGACURE 184), IRGACURE 127, IRGACURE 500 (a mixture of IRGACURE 184 and benzophenone), IRGACURE 2959, IRGACURE 907, IRGACURE 369, IRGACURE 379, IRGACURE 754, IRGACURE 1300, IRGACURE 819, IRGACURE 1700, IRGACURE 1800, IRGACURE 1850, IRGACURE 1870, DAROCURE 4265, DAROCURE MBF, DAROCURE TPO, IRGACURE 784, IRGACURE 754, IRGACURE OXE01 and IRGACURE OXE02. Both of DAROCURE and IRGACURE described above are names of commercial products sold by BASF Japan Ltd. A publicly known sensitizer (isopropyl thioxanthone, diethyl thioxanthone, ethyl-4-dimethylaminobenzoate (DAROCURE EDB), 2-ethylhexyl-4-dimethylaminobenzoate (DAROCURE EHA), or the like) may be added to the initiators.

Other examples of the photoradical polymerization initiators include p-methoxyphenyl-2,4-bis(trichloromethyl)triazine, 2-(p-butoxystyryl)-5-trichloromethyl-1,3,4-oxadiazole, 9-phenylacridine, 9,10-benzphenazine, a benzophenone/Michler's ketone mixture, a hexaarylbiimidazole/mercaptobenzimidazole mixture, 1-(4-isopropylphenyl)-2-hydroxy-2-methylpropane-1-one, benzyldimethyl ketal, 2-methyl-1-[4-(methylthio)phenyl]-2-morpholinopropane-1-one, a 2,4-diethylxanthone/methyl p-dimethylaminobenzoate mixture, and a benzophenone/methyltriethanolamine mixture.

Mechanical characteristics of the polymer can be controlled by adding one kind or two or more kinds of chain transfer agents to the polymerizable liquid crystal composition. When the chain transfer agent is used, a length of a polymer chain or lengths of two crosslinked polymer chains in a polymer film can be controlled. The lengths can also be simultaneously controlled. If an amount of chain transfer agent is increased, the length of the polymer chain decreases. A preferred chain transfer agent is a thiol compound. Specific examples of monofunctional thiol include dodecanethiol and 2-ethylhexyl 3-mercaptopropionate. Specific examples of polyfunctional thiol include trimethylolpropanetris(3-mercaptopropionate), pentaerythritol tetrakis(3-mercaptopropionate), 1,4-bis(3-mercaptobutyryloxy)butane (KARENZ MT BD1), pentaerythritol tetrakis(3-mercaptobutyrate) (KARENZ MT PE1) and 1,3,5-tris(3-mercaptobutyloxyethyl)-1,3,5-triazine-2,4,6(1H,3H,5H)-trione (KARENZ MT NR1). “KARENZ” is a trade name of products of Showa Denko K. K.

A polymerization inhibitor can be added to the polymerizable liquid crystal composition in order to prevent (suppress) polymerization during storage. A publicly known polymerization inhibitor can be used, but preferred examples include 2,5-di(t-butyl)hydroxytoluene (BHT), hydroquinone, methyl blue, diphenyl picryl hydrazide (DPPH), benzothiazine, 4-nitrosodimethylaniline (NIDI) and o-hydroxybenzophenone.

In order to improve storage stability of the polymerizable liquid crystal composition, an oxygen inhibitor can also be added. A radical generated in the composition reacts with oxygen in an atmosphere to yield a peroxide radical, and thus an unwanted reaction with the polymerizable compound is promoted. The oxygen inhibitor is preferably added in order to prevent the unwanted reaction. Specific examples of the oxygen inhibitors include phosphates.

In order to further improve weather resistance of the polymerizable liquid crystal composition, the ultraviolet light absorber, the light stabilizer (radical scavenger), the antioxidant or the like may be added. Specific example of the ultraviolet light absorbers include TINUVIN PS, TINUVIN P, TINUVIN 99-2, TINUVIN 109, TINUVIN 213, TINUVIN 234, TINUVIN 326, TINUVIN 328, TINUVIN 329, TINUVIN 384-2, TINUVIN 571, TINUVIN 900, TINUVIN 928, TINUVIN 1130, TINUVIN 400, TINUVIN 405, TINUVIN 460, TINUVIN 479, TINUVIN 5236, ADEKA STAB LA-32, ADEKA STAB LA-34, ADEKA STAB LA-36, ADEKA STAB LA-31, ADEKA STAB 1413 and ADEKA STAB LA-51. “TINUVIN (registered trademark)” is a trademark of products of Ciba Holding Incorporated, and a trade name of products of BASF Japan Ltd. Moreover, “ADEKA STAB (registered trademark)” is a trade name of products of ADEKA Corporation.

Specific examples of the light stabilizers include TINUVIN 111FDL, TINUVIN 123, TINUVIN 144, TINUVIN 152, TINUVIN 292, TINUVIN 622, TINUVIN 770, TINUVIN 765, TINUVIN 780, TINUVIN 905, TINUVIN 5100, TINUVIN 5050 and 5060, TINUVIN 5151, CHIMASSORB 119FL, CHIMASSORB 944FL, CHIMASSORB 944LD, ADEKA STAB LA-52, ADEKA STAB LA-57, ADEKA STAB LA-62, ADEKA STAB LA-67, ADEKA STAB LA-63P, ADEKA STAB LA-68LD, ADEKA STAB LA-77, ADEKA STAB LA-82, ADEKA STAB LA-87, CYASORB UV-3346 made by Cytec, Inc., and GOODRITE UV-3034 made by Goodrich Corporation. “CHIMASSORB (registered trademark)” is a registered trademark of products of Ciba Holding Incorporated, and a registered trade name of products of BASF Japan Ltd.

Specific examples of the antioxidants include ADEKA STAB AO-20, AO-30, AO-40, AO-50, AO-60 and AO-80, made by ADEKA Corporation, and SUMILIZER (registered trademark) BHT, SUMILIZER BBM-S and SUMILIZER GA-80, sold by Sumitomo Chemical Co., Ltd., and Irganox (registered trademark) 1076, Irganox 1010, Irganox 3114 and Irganox 245, sold by BASF Japan Ltd. The commercial items may be used.

A silane coupling agent may be further added to the polymerizable liquid crystal composition in order to control adhesion with the alignment layer within the range in which an effect of the peeling preventive agent is not adversely affected. Specific examples include vinyltrialkoxysilane, 3-aminopropyltrialkoxysilane. N-(2-aminoethyl)-3-aminopropyltrialkoxysilane, N-(1,3-dimethylbutylidene)-3-triethoxysilyl-1-propanamine, 3-triethoxysilyl-N-(1,3-dimethylbutylidene), 3-glycidoxypropyltrialkoxysilane, 3-chlorotrialkoxysilane and 3-methacryloxypropyltrialkoxysilane. Another example includes dialkoxymethylsilane in which one of alkoxy groups (three) is replaced by methyl in the compounds. Preferred silane coupling agents include 3-aminopropyltriethoxysilane. N-(1,3-dimethylbutylidene)-3-triethoxysilyl-1-propanamine, 3-triethoxysilyl-N-(1,3-dimethylbutylidene), 3-glycidoxypropyltrialkoxysilane and 3-methacryloxypropyltrialkoxysilane.

The polymerizable liquid crystal composition of the invention can be directly applied. However, in order to facilitate application, the polymerizable liquid crystal composition may be diluted with a solvent, as long as the solvent presumably does not corrode the transparent support substrate and the alignment layer. The solvents may be used alone or in combination by mixing two or more solvents. Specific examples of the solvents include an ester solvent, an amide solvent, an alcohol solvent, an ether solvent, a glycol monoalkyl ether solvent, an aromatic hydrocarbon solvent, a halogenated aromatic hydrocarbon solvent, an aliphatic hydrocarbon solvent, a halogenated aliphatic hydrocarbon solvent and an alicyclic hydrocarbon solvent, a ketone solvent and an acetate solvent.

Preferred examples of the ester solvents include alkyl acetate (methyl acetate, ethyl acetate, propyl acetate, isopropyl acetate, butyl acetate, 3-methoxybutyl acetate, isobutyl acetate, pentyl acetate and isopentyl acetate), ethyl trifluoroacetate, alkyl propionate (methyl propionate, methyl 3-methoxypropionate, ethyl propionate, propyl propionate and butyl propionate), alkyl butyrate (methyl butyrate, ethyl butylate, butyl butyrate, isobutyl butyrate and propyl butyrate), dialkyl malonate (diethyl malonate), alkyl glycolate (methyl glycolate and ethyl glycolate), alkyl lactate (methyl lactate, ethyl lactate, isopropyl lactate, n-propyl lactate, butyl lactate and ethylhexyl lactate), monoacetin, γ-butyrolactone and γ-valerolactone.

Preferred examples of the amide solvents include N-methyl-2-pyrrolidone, N,N-dimethylacetamide, N-methylpropionamide, N,N-dimethylformamide, N,N-diethylformamide, N,N-diethylacetamide, N,N-dimethylacetamide dimethyl acetal, N-methylcaprolactam and dimethylimidazolidinone.

Preferred examples of the alcohol solvents include methanol, ethanol, 1-propanol, 2-propanol, 1-methoxy-2-propanol, t-butyl alcohol, sec-butyl alcohol, butanol, 2-ethyl butanol, n-hexanol, n-heptanol, n-octanol, 1-dodecanol, ethyl hexanol, 3,5,5-trimethyl hexanol, n-amyl alcohol, hexafluoro-2-propanol, glycerol, ethylene glycol, diethylene glycol, triethylene glycol, tetraethylene glycol, propylene glycol, dipropylene glycol, tripropylene glycol, hexylene glycol, 1,3-butanediol, 1,4-butanediol, 2,3-butanediol, 1,5-pentanediol, 2,4-pentanediol, 2,5-hexanediol, 3-methyl-3-methoxybutanol, cyclohexanol and methyl cyclohexanol.

Preferred examples of the ether solvents include ethylene glycol dimethyl ether, diethylene glycol dimethyl ether, bis(2-propyl)ether, 1,4-dioxane and tetrahydrofuran (THF).

Preferred examples of the glycol monoalkyl ether solvents include ethylene glycol monoalkyl ether (ethylene glycol monomethyl ether and ethylene glycol monobutyl ether), diethylene glycol monoalkyl ether (diethylene glycol monoethyl ether), triethylene glycol monoalkyl ether, propylene glycol monoalkyl ether (propylene glycol monobutyl ether), dipropylene glycol monoalkyl ether (dipropylene glycol monomethyl ether), ethylene glycol monoalkyl ether acetate (ethylene glycol monobutyl ether acetate), diethylene glycol monoalkyl ether acetate (diethylene glycol monoethyl ether acetate), triethylene glycol monoalkyl ether acetate, propylene glycol monoalkyl ether acetate (propylene glycol monoethyl ether acetate, propylene glycol monoethyl ether acetate and propylene glycol monobutyl ether acetate), dipropylene glycol monoalkyl ether acetate (dipropylene glycol monomethyl ether acetate) and diethylene glycol methyl ethyl ether.

Preferred examples of the aromatic hydrocarbon solvents include benzene, toluene, xylene, anisole, p-cymene, mesitylene, ethylbenzene, diethylbenzene, i-propylbenzene, n-propylbenzene, t-butylbenzene, s-butylbenzene, n-butylbenzene and tetralin. A preferred example of the halogenated aromatic hydrocarbon solvent includes chlorobenzene. Preferred examples of the aliphatic hydrocarbon solvents include hexane and heptane. Preferred examples of the halogenated aliphatic hydrocarbon solvents include chloroform, dichloromethane, carbon tetrachloride, dichloroethane, trichloroethylene and tetrachloroethylene. Preferred examples of the alicyclic hydrocarbon solvents include cyclohexane and decalin.

Preferred examples of the ketone solvents include acetone, methyl ethyl ketone, methyl isobutyl ketone, cyclohexanone, cyclopentanone and methyl propyl ketone.

Preferred examples of the acetate solvents include ethylene glycol monomethyl ether acetate, propylene glycol monoethyl ether acetate, propylene glycol monoethyl ether acetate, methyl acetoacetate and 1-methoxy-2-propyl acetate.

From a viewpoint of solubility of the polymerizable liquid crystal compound, use of the amide solvent, the aromatic hydrocarbon solvent or the ketone solvent is preferred, and when a boiling point of the solvent is taken into consideration, combined use of the ester solvent, the alcohol solvent, the ether solvent and the glycol monoalkyl ether solvent is also preferred. Selection of the solvent is not particularly limited, but when a plastic substrate is used as the transparent support substrate, a decrease in drying temperature, and prevention of the transparent support substrate from being corroded by the solvent are required in order to prevent deformation of the substrate. Solvents preferably used in such a case include an aromatic hydrocarbon solvent, a ketone solvent, an ester solvent, an ether solvent, an alcohol solvent, an acetate solvent and a glycol monoalkyl ether solvent.

A ratio of a solvent in a solution of the polymerizable liquid crystal composition is in the range of approximately 0 to approximately 95% based on the total weight of the solution. A lower limit of the range represents a numerical value in consideration of a case where the transparent support substrate is subjected to corrosion with the solvent. Then, an upper limit of the range represents a numerical value in consideration of solution viscosity, solvent cost and productivity such as time and a quantity of heat upon evaporating the solvent. A preferred ratio is in the range of approximately 0 to approximately 90%. A further preferred ratio is in the range is approximately 0 to approximately 85%.

The patterned retarder of the invention is formed as described below.

As a first method of formation, an alignment layer formed on a transparent support substrate is subjected to patterned treatment, and a mixture of a polymerizable liquid crystal compound and a peeling preventive agent, or a solution of the mixture is applied and dried, and thus a paint film is formed. Next, the paint film is irradiated with light to allow polymerization to immobilize nematic alignment that is formed in a composition in the paint film in a liquid crystal state.

As a second method of formation, an alignment layer formed on a transparent support substrate is subjected to uniform alignment treatment, a mixture of a polymerizable liquid crystal compound and a peeling preventive agent, or a solution of the mixture is applied and dried to form a paint film, a polymerizable liquid crystal layer subjected to alignment treatment in an identical direction is irradiated with light through a photomask to allow polymerization to immobilize nematic alignment. Here, an unirradiated region is removed using a solvent.

As a third method of formation, an alignment layer formed on a transparent support substrate is subjected to uniform alignment treatment, a mixture of a polymerizable liquid crystal compound and a peeling preventive agent, or a solution of the mixture is applied and dried to form a paint film, a polymerizable liquid crystal layer subjected to alignment treatment in an identical direction is irradiated with light through a photomask to allow polymerization to immobilize nematic alignment. Here, an unirradiated region is polymerized by light or heat in a state in which the unirradiated region is changed to an isotropic phase that does not develop a liquid crystal phase by heating.

The transparent support substrates that can be used are glass and a plastic film. Specific examples of the plastic films include a film of polyimide, polyamideimide, polyamide, polyetherimide, polyether ether ketone, polyether ketone, polyketone sulfide, polyethersulfone, polysulfone, polyphenylene sulfide, polyphenylene oxide, polyethylene terephthalate, polybutyrene terephthalate, polyethylene naphthalate, polyacetal, polycarbonate, polyarylate, an acrylic resin, polyvinyl alcohol, polypropylene, cellulose, triacetylcellulose and a partially saponified product, an epoxy resin, a phenolic resin and a cycloolefin resin.

Specific examples of the cycloolefin resins include a norbornene resin and a dicyclopentadiene resin, but are not limited thereto. Among the resins, a resin having no unsaturated bond or a resin in which an unsaturated bond is hydrogenated is suitably used. Specific examples include a hydrogenated product of a ring-opening (co)polymer of one or two or more of norbornene monomers, an addition (co)polymer of one or two or more of norbornene monomers, an addition copolymer of a norbornene monomer and an olefin monomer (ethylene or α-olefin), an addition copolymer of a norbornene monomer and a cycloolefin monomer (cyclopentene, cyclooctane or 5,6-dihydrodicyclopentadiene) and a modified product thereof. Specific examples include ZEONEX (registered trademark), ZEONOR (registered trademark, made by Zeon Corporation), ARTON (made by JSR Corporation), TOPAS (registered trademark, made by Ticona GmbH), APEL (registered trademark, made by Mitsui Chemicals, Inc.), ESCENA (registered trademark, made by Sekisui Chemical Co., Ltd.) and OPTOREZ (made by Hitachi Chemical Co., Ltd.).

The plastic films may be uniaxially oriented or biaxially oriented. The plastic films may be subjected to surface treatment, such as hydrophilic treatment including corona treatment and plasma treatment, or hydrophobic treatment. A hydrophilic treatment method is not particularly limited, but corona treatment or plasma treatment is preferred, and a particularly preferred method includes plasma treatment. With regard to the corona treatment, the method described in JP 2002-226616 A, JP 2002-121648A or the like may be applied. Moreover, in order to improve adhesion between the liquid crystal film and the plastic film, an anchor coat layer may be formed. Such an anchor coat layer may be formed using any of an inorganic material or an organic material without any problem, if the layer improves adhesion between the plastic film and the alignment layer or the patterned retarder. Moreover, the plastic film may be formed as a laminated film. In place of the plastic film, such a support substrate can also be used, as a metal substrate made from aluminum, iron or copper and having a slit-shaped groove on a surface, or a glass substrate made from alkaline glass, borosilicate glass or flint glass and subjected to etching processing in a slit shape on a surface.

On the transparent support substrate such as the glass or the plastic film, physical or mechanical surface treatment by rubbing or the like may be applied prior to formation of the paint film of the mixture of the polymerizable liquid crystal composition and the peeling preventive agent. When homeotropic alignment is applied to part of the patterned retarder, the surface treatment by rubbing or the like is not applied in many cases, but rubbing treatment may be applied in view of preventing an alignment defect or the like. An arbitrary method can be employed as rubbing treatment. Such a method is ordinarily employed as a method for winding around a metallic roll a rubbing cloth made from a raw material such as rayon, cotton and polyamide, and moving the roll while rotating the roll in a state in contact with the transparent support substrate or the alignment layer, or a method for moving a side of the support substrate while fixing the roll. The rubbing treatment may be directly applied onto the transparent support substrate, or an alignment layer is arranged onto the transparent support substrate in advance, and the rubbing treatment may be applied onto the alignment layer. The rubbing treatment method is as described above. Depending on kinds of transparent support substrates, alignment ability can also be provided by performing inclined deposition of silicon oxide on a surface of the support substrate.

Upon applying the mixture of the polymerizable liquid crystal compound and the peeling preventive agent or the solution thereof, examples of application methods for obtaining a uniform film thickness include a spin coating method, a microgravure coating method, a gravure coating method, a wire-bar coating method, a dip coating method, a spray coating method, a meniscus coating method and a die coating method. In particular, a wire-bar coating method or the like in which shear stress is applied to the liquid crystal compound during application may be applied when alignment of the liquid crystal compound is controlled without applying the surface treatment of the transparent support substrate by rubbing or the like.

Upon applying the mixture of the polymerizable liquid crystal compound and the peeling preventive agent or the solution thereof according to the invention, a solvent may be occasionally added. A mixture containing the polymerizable liquid crystal compound and the peeling preventive agent, the additive and the solvent according to the invention is generically described as a solution of the polymerizable liquid crystal composition. Combinations described below are also described in a similar manner.

A combination of the polymerizable liquid crystal compound and the peeling preventive agent, the additive, the solvent and any other polymerizable compound.

A combination of the polymerizable liquid crystal compound and the peeling preventive agent, the additive and the solvent.

In addition, in a case where the polymerizable liquid crystal compound and the peeling preventive agent, and the additive are combined, or in a case where the polymerizable liquid crystal compound and the peeling preventive agent, the additive and any other polymerizable compound are combined, the mixture is described as a polymerizable liquid crystal composition.

Upon applying the solution of the polymerizable liquid crystal composition, when a solvent is included, the solvent is removed after application, and a polymerizable liquid crystal layer having a uniform film thickness, more specifically, a layer formed of the polymerizable liquid crystal composition is formed on the transparent support substrate. Conditions for removing the solvent are not particularly limited. Such conditions may be applied that solvent is substantially removed to be dried until flow properties of the paint film formed of the polymerizable liquid crystal composition disappear. The solvent can be removed utilizing air drying at room temperature, drying on a hot plate, drying in a drying oven, blowing of warm air or hot air, or the like. Depending on kinds or composition ratios of the polymerizable liquid crystal compounds, nematic alignment in the paint film may be occasionally completed in a process for drying the paint film. Therefore, a paint film through a drying step can be provided for a polymerization step without passing through a heat treatment step as described later.

With regard to temperature and time upon applying heat treatment to the paint film, a wavelength of light to be used for irradiation with light, an amount of light irradiated from a light source, or the like, preferred ranges are different depending on kinds and composition ratios of the polymerizable liquid crystal compounds, presence or absence of addition of the polymerization initiator, and an amount of addition of the initiator, or the like. Therefore, conditions of the temperature and the time of the heat treatment to the paint film, the wavelength of light to be used for irradiation with light, and the amount of light irradiated from the light source as described later represent generalities persistently.

The heat treatment to the paint film is preferably applied under conditions in which the solvent is removed and uniform alignment properties of the polymerizable liquid crystal compound are obtained. The heat treatment may be applied at a liquid crystal phase transition temperature of the polymerizable liquid crystal compound, or higher. One example of the heat treatment methods includes a method for warming a paint film to a temperature at which the polymerizable liquid crystal compound shows a nematic liquid crystal phase to form nematic alignment in the polymerizable liquid crystal compound in the paint film. The nematic alignment may be formed by changing temperatures of the paint film within a temperature range in which the polymerizable liquid crystal compound shows the nematic liquid crystal phase. According to the method, the nematic alignment is substantially completed in the paint film by warming the paint film to a high-temperature region in the temperature range, and subsequently further ordered alignment is formed by decreasing the temperature. In a case where any of the heat treatment methods described above is employed, a heat treatment temperature is in the range of approximately room temperature to approximately 120° C. A preferred temperature is in the range of approximately room temperature to approximately 100° C. A further preferred temperature is in the range of approximately room temperature to approximately 90° C. A still further preferred temperature is in the range of approximately room temperature to approximately 80° C. Heat treating time is in the range of approximately 5 seconds to approximately 2 hours. Preferred time is in the range of approximately 10 seconds to approximately 40 minutes. Further preferred time is in the range of approximately 20 seconds to approximately 20 minutes. In order to increase a temperature of the polymerizable liquid crystal layer to a predetermined temperature, the heat treating time is preferably set to approximately 5 seconds or more. In order to avoid a decrease in productivity, the heat treating time is preferably set within approximately 2 hours. Thus, the polymerizable liquid crystal layer of the invention is obtained.

A nematic alignment state of the polymerizable liquid crystal compound as formed in the polymerizable liquid crystal layer is immobilized by polymerizing the polymerizable liquid crystal compound by irradiation with light. A wavelength of light used for irradiation with light is not particularly limited. An electron beam, ultraviolet light, visible light, infrared light (heat rays) or the like can be utilized. Ultraviolet light or visible light may be ordinarily used. A range of the wavelength is approximately 150 to approximately 500 nanometers. A preferred range is approximately 250 to approximately 450 nanometers, and a further preferred range is approximately 300 to approximately 400 nanometers. Examples of the light sources include a low-pressure mercury lamp (a bactericidal lamp, a fluorescent chemical lamp, a black light), a high-pressure discharge lamp (a high-pressure mercury lamp, a metal halide lamp), and a short arc discharge lamp (an ultra-high pressure mercury lamp, a xenon lamp, a mercury-xenon lamp). Preferred examples of the light sources include a metal halide lamp, a xenon lamp, an ultra-high pressure mercury lamp and a high-pressure mercury lamp. A wavelength region of an irradiation light source may be selected by installing a filter or the like between the light source and the polymerizable liquid crystal layer, and passing only a specific wavelength region through the filter or the like. An amount of light irradiated from the light source is in the range of approximately 2 to approximately 5,000 mJ/cm². A preferred range of the amount of light is approximately 10 to approximately 3,000 mJ/cm², and a further preferred range is approximately 100 to approximately 2,000 mJ/cm². Temperature conditions during irradiation with light are preferably set in a manner similar to the heat treatment temperature as described above. Moreover, an atmosphere of a polymerization environment may include any of a nitrogen atmosphere, an inert gas atmosphere and an air atmosphere, but from a viewpoint of improving curing properties, a nitrogen atmosphere or an inert gas atmosphere is preferred.

When the polymerizable liquid crystal layer and the patterned retarder obtained by polymerizing the polymerizable liquid crystal compound with light, heat or the like according to the invention is used for various kinds of optical devices, or when the layer or the plate is applied to an optical compensation device to be used for the liquid crystal display apparatus, control of distribution of tilt angles in a thickness direction becomes significantly important.

One of the methods for controlling the tilt angle includes a method for adjusting kinds or composition ratios of the polymerizable liquid crystal compounds. The tilt angle can also be controlled by adding any other component to the polymerizable liquid crystal compound. The tilt angle can also be controlled by kinds of solvents or a solute concentration, kinds of surfactants to be added as one of other components and an amount of addition of surfactant, or the like. The tilt angle can also be controlled by kinds or the transparent support substrates or the alignment layers or alignment treatment conditions therefor, drying conditions or heat treatment conditions of the paint film formed of the polymerizable liquid crystal compound the peeling preventive agent, or the like. Furthermore, an irradiation atmosphere or temperature during irradiation in a photopolymerization step after alignment, or the like also influences the tilt angle. More specifically, almost all of conditions in processes for manufacturing the patterned retarder may be considered to influence the tilt angle in any way. Therefore, an arbitrary tilt angle can be formed by optimizing the polymerizable liquid crystal compound and also appropriately selecting various conditions of processes for manufacturing the patterned retarder.

When a homogeneous alignment agent is formed on the transparent support substrate, alignment treatment is required. As the alignment treatment, a rubbing method or a photoalignment method is applied. When the rubbing method is applied, an alignment film of a polyimide or polyvinyl alcohol material is used. When the photoalignment method is applied, a photoalignment film mainly containing a (meth)acrylate polymer, a cycloolefin polymer, a siloxane polymer or the like is used. When the photoalignment film is used, a polymer structure is required to have a photosensitive unit. In order to align the polymerizable liquid crystal compound, a polymer having as a photosensitive unit a photoisomerization type polymer in which the photosensitive unit is an azo unit, a photodimerization type polymer having a cinnamate unit or a chalcone unit, or a photolysis type polymer having a cyclobutane unit is preferably, used, and in view of sensitivity, a photodimerization type polymer is further preferably used. As the photodimerization type polymer, a (meth)acrylate polymer, a cycloolefin polymer or a siloxane polymer or the like is preferably used, and a (meth)acrylate polymer or a cycloolefin polymer having in a polymer side chain a cinnamate unit or a chalcone unit as the photodimerization unit is further preferably used.

In addition, the polymerizable liquid crystal compound may be occasionally homogeneously aligned by applying a method for directly applying the rubbing treatment to the transparent support substrate, or applying a film subjected to stretching treatment as the transparent support substrate.

When a homeotropic alignment agent is formed on the transparent support substrate, specific examples includes utilization of a silane coupling agent such as octadecyltriethoxysilane, lecithin, a chromium complex, a polyimide alignment film for homeotropic alignment, a film calcinated at a low temperature (less than 180° C.) of a polyamic acid alignment film, a film calcinated at a high temperature (180° C. or higher) of a polyamic acid alignment film or a water-soluble silsesquioxane film. Furthermore, the tilt angle can also be controlled by applying an electric field, a magnetic field or the like.

With regard to a thickness of the patterned retarder, the thickness is different depending on retardation according to a target device or birefringence (Δn) of the polymerizable liquid crystal compounds constituting the polymerizable liquid crystal layer. A preferred thickness of the patterned retarder is in the range of approximately 0.05 to approximately 50 micrometers. Then, a further preferred thickness is in the range of approximately 0.1 to approximately 20 micrometers, and a still further preferred thickness is in the range of approximately 0.5 to approximately 10 micrometers. A preferred haze value of the liquid crystal film is in the range of approximately 1.5% or less, and preferred transmittance is in the range of approximately 80% or more. A further preferred haze value is in the range of approximately 1.0% or less, and further preferred transmittance is in the range of approximately 95% or more. Transmittance preferably satisfies the conditions in a visible light region. When the polymerizable liquid crystal layers are laminated and used, as shown in FIG. 4, the second polymerizable liquid crystal layer may be arranged on the first polymerizable liquid crystal layer so as to be approximately 0.4 times to approximately 10.0 times, preferably, approximately 1.0 times to approximately 6.0 times, further preferably, approximately 1.2 times to approximately 6.0 times, on the basis of a thickness of the first polymerizable liquid crystal layer.

The patterned retarder is effective as an optical device to be applied to the liquid crystal display device (in particular, an active matrix mode liquid crystal display device and a passive matrix mode liquid crystal display device) or an optical device to be applied to organic electroluminescence. Examples of modes of the liquid crystal display devices suitable for using the pattered retarder include an in-plane switching (IPS) mode, an optically compensated birefringence (OCB) mode, a twisted nematic (TN) mode, a super-twisted nematic (STN) mode, an electrically controlled birefringence (ECB) mode, a deformation of aligned phases (DAP) mode, a color super homeotropic (CSH) mode, a vertically aligned nematic/vertically aligned cholesteric (VAN/VAC) mode, an optical modal interference (OMI) mode and a super birefringence effect (SBE) mode. Furthermore, the patterned retarder can also be used as a display device for a guest-host mode, a ferroelectric mode, an antiferroelectric mode, or the like. In addition, optimum values of parameters such as a distribution of tilt angles in a thickness direction, or a thickness required for the patterned retarder are different depending on kinds of devices because the optimum values strongly depend on kinds of liquid crystal display devices to be compensated, and optical parameters thereof. The patterned retarders include a ¼ λ plate and a ½λ plate. The plates are obtained when the polymerizable liquid crystal compound is homogeneously aligned. The homogeneous alignment represents a state in which the alignment state is parallel to the transparent support substrate, and aligned in one direction in a predetermined alignment treatment region. In addition, examples of the tilt angles in the homogeneous alignment include 0 degrees to 5 degrees.

The three-dimensional image display apparatus are described in EP 0829744 A, EP 0887666 A, EP 0887692 A, U.S. Pat. No. 6,046,849 B and U.S. Pat. No. 6,437,915 B. In a case where the patterned retarder is applied to an organic electroluminescent display device, when a constitution is formed in which linearly polarized light is emitted from a panel, a three-dimensional image display can be made by using the patterned retarder of the invention.

The patterned retarder can also be used as an optical device integrated with a polarizing plate or the like, and in the case, the patterned retarder is arranged outside a liquid crystal cell. However, the patterned retarder can also be arranged inside the liquid crystal cell due to no elution or only a small amount of elution of an impurity to a liquid crystal filled in the cell. If a photolithography technology is applied, patterned retarders having different optical parameters can be arranged according to each picture element having a different wavelength region such as blue, green and red in the liquid crystal display device or arranged in a predetermined region that is partitioned by dividing one picture element. For example, if the method disclosed in JP 2001-222009 A is applied, when one picture element is divided into a reflection display unit, and a transmission display unit in which a ¼λ plate formed of the liquid crystal film is arranged, a transflective liquid crystal display device having improved light utilization efficiency can be structured. More specifically, display performance of the liquid crystal display device can be further improved.

It will be apparent to those skilled in the art that various modifications and variations can be made in the invention and specific examples provided herein without departing from the spirit or scope of the invention. Thus, it is intended that the invention covers the modifications and variations of this invention that come within the scope of any claims and their equivalents.

The following examples are for illustrative purposes only and are not intended, nor should they be interpreted to, limit the scope of the invention.

### EXAMPLES

Hereinafter, the invention will be explained in detail by way of Examples, but the invention is not limited to the Examples.

### Example 1

As transparent support substrate 301, a film having a thickness of 60 micrometers prepared using triacetyl cellulose was prepared. On the transparent support substrate 301, an aligning agent (a copolymer of 2-[4-[(E)-2-methoxycarbonylvinyl]phenoxy]ethyl-2-methylacrylate (A component) and 2-hydroxyethyl methacrylate (B component), a copolymerization ratio=A component/B component=7/3 (weight ratio), weight average molecular weight: approximately 70,000, solvent: toluene/1-methoxy-2-propanol=1/1 (weight ratio), polymer concentration: 5 wt %) was applied by means of a spin coater, an applied surface was dried at 100° C. for 1 minute, and thus alignment film 302 having a thickness of 0.1 micrometer was formed. An applied surface of the alignment film was exposed, using a mask patterned in a stripe shape, with linearly polarized ultraviolet light having a wavelength near 313 nanometers from a direction of 90 degrees relative to the applied surface. In exposure, the applied surface was exposed with the linearly polarized light such that a direction of alignment of liquid crystal molecules to be applied, and a longitudinal direction of the transparent support substrate became in parallel to each other. Next, the photomask was removed and the applied surface was exposed with the linearly polarized light in a direction perpendicular to a first exposure direction. Thus, alignment film 103 was formed in which liquid crystal molecules were aligned in directions 104 in parallel to and perpendicular to longitudinal direction 102 of transparent support substrate 301. Then, on the alignment film, a solution was applied by means of a spin coater, in which the solution contained a polymerizable liquid crystal compound (LC-242, made by BASF) and a peeling preventive agent (glycerol methacrylate, BLEMMER (registered trademark) GLM, made by NOF Corporation) at a solvent composition of toluene/1-methoxy-2-propanol=1/1 (weight ratio), and a concentration of the polymerizable liquid crystal compound was 25% by weight.

Here, based on the total weight of the polymerizable liquid crystal compound, 10% by weight of the peeling preventive agent, 5% by weight of IRGACURE (registered trademark) 907 (made by BASF Japan Inc.), and 0.2% by weight of BYK-361N (made by BYK-Chemie GmbH) as a surfactant were added.

Then, an applied surface was dried at 60° C. for 1 minute to align the liquid crystal molecules in each direction of the alignment film, and then was irradiated with light having an intensity of 30 mW/cm² (365 nm) for 30 minutes at room temperature in air by using a 250 W ultra-high pressure mercury lamp, and thus a sample of a patterned wavelength plate was obtained. The sample and OPTIPRO Polarimeter made by Shintech, Inc. were used, and a liquid crystal film on the substrate was irradiated with light having a wavelength of 550 nanometers. While an incident angle of light was decreased from 90 degrees relative to the film surface, retardation was measured. Retardation is expressed by Δn d. A symbol “Δn” represents optical anisotropy and a symbol “d” represents a thickness of the polymer film. Retardation when the incident angle was 90 degrees relative to the film surface was approximately 140 nanometers, and left and right were symmetrical, and thus a ¼λ wavelength plate having a tilt angle of 0 degrees was provided.

In accordance with the method described in JIS K5400, a surface of a patterned retarder obtained was cut in 100 squares in a cross-cut shape by using a cutter knife, a cellophane tape (registered trademark) was once adhered thereon, and then peeled off, a ratio of the number of squares remaining on the substrate to 100 squares was expressed as a film remaining ratio (%), and thus strength of adhesion was evaluated (a higher remaining ratio means a higher strength of adhesion). As a result, a film remaining ratio in a polymerizable liquid crystal layer region of the patterned retarder was 100%.

### Comparative Example 1

A sample of a patterned ¼λ wavelength plate was prepared in a manner similar to the operations in Example 1 except that a solution consisting of the polymerizable liquid crystal compound was applied onto the alignment layer as described in Example 1. When adhesion with regard to the sample was evaluated, a film remaining ratio in a polymerizable liquid crystal layer region was 0%.

### Example 2

A patterned retarder was prepared in a manner similar to the operations in Example 1 except that, based on the total weight of the polymerizable liquid crystal compound, 1% by weight of 2-acryloyloxyethyl succinate (LIGHT ACRYLATE (registered trademark) HOA-MS (N), made by Kyoeisha Chemical Co., Ltd.) was added as a peeling preventive agent. When adhesion with regard to the patterned retarder obtained was evaluated in a manner similar to the operations in Example 1, a film remaining ratio in a polymerizable liquid crystal layer region in the patterned retarder was 100%.

### Example 3

A patterned retarder was prepared in a manner similar to the operations in Example 1 except that, based on the total weight of the polymerizable liquid crystal compound, 3% by weight of an aminated acrylic polymer (POLYMENT (registered trademark) NK-380, made by Nippon Shokubai Co., Ltd.) was added as a peeling preventive agent. When adhesion with regard to the patterned retarder obtained was evaluated in a manner similar to the operations in Example 1, a film remaining ratio in a polymerizable liquid crystal layer region in the patterned retarder was 100%.

### Example 4

As transparent support substrate 301, a glass substrate was prepared. On the glass substrate, as an aligning agent, a polyamic acid type alignment film (LIXON ALIGNER (registered trademark) PIA-5370, made by JNC Corporation) was coated by means of a spin coater, a coated alignment film was baked at 230° C. for 30 minutes, subjected to rubbing treatment using a rayon cloth, and thus alignment film 302 having a thickness of approximately 0.1 micrometer was formed. Next, the solution containing the polymerizable liquid crystal compound, the peeling preventive agent, the polymerization initiator and the surfactant as described Example 1 was applied, and an applied surface was dried at 60° C. for 1 minute, and then was irradiated with light having an intensity of 30 mW/cm² (365 nm) for 30 minutes at room temperature in air by using a 250 W ultra-high pressure mercury lamp, and thus a sample of a wavelength plate having a single alignment direction was obtained. When retardation of the sample was measured in a manner similar to the operations in Example 1, retardation when the incident angle was 90 degrees relative to the film surface was approximately 135 nanometers, and left and right were symmetrical, and thus a ¼λ wavelength plate having a tilt angle of 0 degrees was provided. Next, as described in Example 1 except that a concentration of the polymerizable liquid crystal compound was changed to 30% by weight, a solution containing the peeling preventive agent (1% by weight of LIGHT ACRYLATE (registered trademark) HOA-MS (N) based on the total amount of the polymerizable liquid crystal compound), the polymerization initiator and the surfactant was applied onto the sample of the ¼λ wavelength plate, and an applied surface was dried at 60° C. for 1 minute. Then, the applied surface was exposed, using a mask patterned in a stripe shape, with unpolarized ultraviolet light, and an unexposed area was washed and removed with toluene, and thus a sample (polymerizable liquid crystal layer 303) of a retarder in which a ½λ plate was patterned on the ¼λ plate was obtained.

When adhesion with regard to the patterned retarder obtained was evaluated in a manner similar to the operations in Example 1, a film remaining ratio in a polymerizable liquid crystal layer region in the patterned retarder was 100%.

### Comparative Example 2

A sample of a patterned retarder was prepared in a manner similar to the operations in Example 4 except that the solution consisting of the polymerizable liquid crystal compound, the polymerization initiator and the surfactant was applied onto the alignment layer subjected to rubbing treatment as described in Example 4. When adhesion with regard to the sample was evaluated in a manner similar to the operations in Example 1, a film remaining ratio in a polymerizable liquid crystal layer region in the patterned retarder was 0%.

The results in the Examples and the Comparative Examples described above show that the patterned retarder of the invention has superior adhesion with the transparent support substrate.

Although the invention has been described and illustrated with a certain degree of particularity; it is understood that the disclosure has been made only by way of example, and that numerous changes in the conditions and order of steps can be resorted to by those skilled in the art without departing from the spirit and scope of the invention.

### INDUSTRIAL APPLICABILITY

A patterned retarder of the invention has excellent adhesion with a transparent support substrate, and thus even if a protective film is stuck on the patterned retarder in a manufacturing step before combining with a three-dimensional image display apparatus, a retardant region is not peeled off. Moreover, even after the patterned retarder is assembled into the three-dimensional image display apparatus, the patterned retarder is not peeled off from the apparatus. Therefore, a three-dimensional image display apparatus having excellent long-term reliability can be obtained.

Although a few embodiments of the present invention have been shown and described, it would be appreciated by those skilled in the art that changes may be made in this embodiment without departing from the principles and spirit of the invention, the scope of which is defined in the claims and their equivalents.

1. A three-dimensional image display apparatus, comprising a patterned retarder prepared by arranging on a transparent support substrate an alignment film subjected to treatment so as to be in a state in which alignment directions of liquid crystal molecules are different in adjacent regions in an identical plane, arranging on the alignment film a polymerizable liquid crystal layer including a polymerizable liquid crystal compound and a peeling preventive agent, and subsequently allowing the polymerizable liquid crystal compound to align in a direction of alignment treatment of the alignment film, and immobilizing alignment of the polymerizable liquid crystal compound by irradiation with light.

2. A three-dimensional image display apparatus, comprising a patterned retarder prepared by arranging on a transparent support substrate an alignment film subjected to treatment so as for a direction of alignment of liquid crystal molecules to become single, arranging on the alignment film a first polymerizable liquid crystal layer including a polymerizable liquid crystal compound and a peeling preventive agent, and subsequently allowing the polymerizable liquid crystal compound to align in a direction of alignment treatment of the alignment film, and immobilizing alignment of the polymerizable liquid crystal compound by irradiation with light, and subsequently arranging on the first polymerizable liquid crystal layer a second polymerizable liquid crystal layer including a polymerizable liquid crystal compound and a peeling preventive agent so as to be 0.4 times to 10.0 times on the basis of a thickness of the first polymerizable liquid crystal layer, and allowing the second polymerizable liquid crystal compound to align in a direction identical with the direction of the first polymerizable liquid crystal layer to immobilize alignment of the polymerizable compound by irradiation with light using a photomask, and removing a light-unirradiated part of the second polymerizable liquid crystal layer by using a solvent or by heating to be immobilized in a state of an isotropic phase.

3. The three-dimensional image display apparatus according to claim 1, wherein the peeling preventive agent is a polymerizable compound having a polymerizable group, and having as a polar group at least any one of a hydroxyl group, a carboxyl group, a phosphate group, a sulfonate group, an amino group, a mercapto group and an isocyanate group, or the peeling preventive agent is a polymer having as a polar group at least any one of a hydroxyl group, a carboxyl group, a phosphate group, a sulfonate group, an amino group, a mercapto group and an isocyanate group.

4. The three-dimensional image display apparatus according to claim 2, wherein the peeling preventive agent is a polymerizable compound having a polymerizable group, and having as a polar group at least any one of a hydroxyl group, a carboxyl group, a phosphate group, a sulfonate group, an amino group, a mercapto group and an isocyanate group, or the peeling preventive agent is a polymer having as a polar group at least any one of a hydroxyl group, a carboxyl group, a phosphate group, a sulfonate group, an amino group, a mercapto group and an isocyanate group.

5. The three-dimensional image display apparatus according to claim 3, including one kind or two or more kinds of peeling preventive agents in an amount of 0.1 to 20% by weight based on the total weight of the polymerizable liquid crystal compound.

6. The three-dimensional image display apparatus according to claim 4, including one kind or two or more kinds of peeling preventive agents in an amount of 0.1 to 20% by weight based on the total weight of the polymerizable liquid crystal compound.

7. The three-dimensional image display apparatus according to claim 1, wherein, as a method for controlling a direction of alignment of liquid crystal molecules, any one of a rubbing method, a photoalignment treatment method, a nanoimprinting method and a stretching method is applied.

8. The three-dimensional image display apparatus according to claim 2, wherein, as a method for controlling a direction of alignment of liquid crystal molecules, any one of a rubbing method, a photoalignment treatment method, a nanoimprinting method and a stretching method is applied.

9. The three-dimensional image display apparatus according to claim 1, wherein the peeling preventive agent is a polymerizable compound having as a polymerizable group any one of an acryloyloxy group and a methacryloyloxy group.

10. The three-dimensional image display apparatus according to claim 2, wherein the peeling preventive agent is a polymerizable compound having as a polymerizable group any one of an acryloyloxy group and a methacryloyloxy group.

11. The three-dimensional image display apparatus according to claim 1, using a liquid crystal display device.

12. The three-dimensional image display apparatus according to claim 2, using a liquid crystal display device.

13. A method comprising:
applying a peeling preventive agent to a patterned retarder, wherein the peeling preventive agent is a polymerizable compound having a polymerizable group, and having as a polar group any one of a hydroxyl group, a carboxyl group, a phosphate group, a sulfonate group, an amino group, a mercapto group and an isocyanate group, or the peeling preventive agent is a polymer having as a polar group at least any one of a hydroxyl group, a carboxyl group, a phosphate group, a sulfonate group, an amino group, a mercapto group and an isocyanate group.

14. The method of claim 13, further comprising:
applying the patterned retarder to a three-dimensional image display apparatus.
